(19) United States
(12) Patent Application Publication
(10) Pub. No.: US 2026/0093447 A1
(43) Pub. Date: Apr. 2, 2026

(54) GESTURE BASED INVOCATION OF ACTIONS FOR INTERACTION WITH A PHYSICAL ENVIRONMENT

(71) Applicant: Apple Inc., Cupertino, CA (US)

(72) Inventors: Thomas J. MOORE, Northglenn, CO (US); Peter BURGNER, Venice, CA (US); Evan JONES, Kirkland, WA (US); Guilherme KLINK, Campbell, CA (US); Tigran KHACHATRYAN, North Hills, CA (US); Paulo R. JANSEN DOS REIS, San Jose, CA (US); Christopher D. FU, Fremont, CA (US); Jiahui CHEN, Stanford, CA (US)

(21) Appl. No.: 19/303,045

(22) Filed: Aug. 18, 2025

Related U.S. Application Data
(60) Provisional application No. 63/700,663, filed on Sep. 28, 2024.

(51) Int. Cl. G06F 3/16

(52) U.S. Cl. CPC G06F 3/167

(57) ABSTRACT

Some examples of the disclosure are directed to systems and methods for presenting one or more user interface elements including informational content related to information (e.g., textual information) found in an indicated region of the physical environment. In some examples, after confirming that one or more portions of a user satisfy one or more criteria (e.g., one or more portions of a user indicating a region a physical environment including textual information), the electronic device initiates image processing to generate a representation of the region of the physical environment, and optionally provides informational content related to the identified region of the physical environment.

### CROSS REFERENCE TO RELATED APPLICATIONS

This application claims the benefit of U.S. Provisional Application No. 63/700,663, filed Sep. 28, 2024, the content of which is herein incorporated by reference in its entirety for all purposes.

### FIELD OF THE DISCLOSURE

This relates generally to systems and methods of gesture-based invocation of actions and commands for interacting with informational content in one or more regions of a physical environment.

### BACKGROUND OF THE DISCLOSURE

Some computer graphical environments provide two-dimensional and/or three-dimensional environments where at least some objects displayed for a user's viewing are virtual and generated by a computer. In some examples, a physical environment (e.g., including one or more physical objects) is presented, optionally along with one or more virtual objects, in a three-dimensional environment.

### SUMMARY OF THE DISCLOSURE

Some examples of the disclosure are directed to systems and methods for the interaction of an electronic device with the physical environment, wherein the electronic device further provides relevant information related to the information identified and detected in the physical environment. In some examples, the electronic device is a head worn electronic device.

In some examples, the present disclosure provides methods for initiating processes (e.g., images processing, text recognition, saving) on views of the physical environment viewed by a user at an electronic device. The provided methods of initiating processes reduce the number of inputs required by a user to interact with the physical environment and/or with an electronic device. For example, the user does not need to take physical actions to perform contextual searching on informational content or copy informational content. Additionally or alternatively, the user does not need to take further actions (e.g., no need for button presses, touch inputs, verbal commands to a digital assistant, etc.) to instruct the electronic device to recognize, process, and/or perform operations on informational content designated by the user within the field of view of the electronic device. Accordingly, the methods described herein reduce the processor tasking and power consumption of the electronic device. Furthermore, the initiation of one or more processes through predetermined gestures results in a more intuitive, action efficient, and streamlined experience for a user.

In some examples, a method is performed at an electronic device in communication with one or more displays and a plurality of input devices including one or more motion sensors and one or more optical sensors. In some examples, the electronic device detects, via the one or more optical sensors, one or more portions of a user directed toward a first object in a physical environment. In some examples, in response to detecting that the one or more portions of a user are directed toward the first object satisfy one or more first criteria (e.g., an extended finger pointing at portion of first object), the electronic device presents, via the one or more displays, first content (e.g., a first user interface element, a first audio output, etc.) in association with the one or more portions of the user and the first object, wherein the first content includes informational content associated with the first object. For instance, a first extended finger directed toward (e.g., pointing at) a first object satisfies one or more first criteria, and when the first extended finger indicates one or more target words, the electronic device presents a user interface element which includes informational content related to the one or more target words.

In some examples, in accordance with a determination that the one or more portions of the user (e.g., two extended fingers) being directed toward the first object satisfies one or more second criteria, the electronic device presents, via the one or more displays, second content in association with the one or more portions of the user and the first object, wherein the first content includes informational content associated with the first object. For instance, a first extended finger and a second extended finger directed toward (e.g., pointing at) a first object satisfies one or more second criteria, and when the extended fingers indicate a string of text and/or multiple lines of text bounded by an area designated by the location of the extended fingers, the electronic device presents a user interface element which includes informational content related to the string of text and/or multiple lines of text.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting a three-dimensional environment according to some examples of the disclosure.

FIG. 2A-2B illustrates a block diagram of example architectures for electronic devices according to some examples of the disclosure.

FIGS. 3A-3J illustrate various examples of an electronic device and user interactions with the electronic device, wherein the electronic device optionally presents content with information associated with an identified region of a physical environment, according to some examples of the disclosure.

FIG. 4 illustrates a flow diagram for an example process for an electronic device interacting with the physical environment, according to some examples of the disclosure.

### DETAILED DESCRIPTION

Some examples of the disclosure are directed to systems and methods for the interaction of an electronic device with the physical environment, wherein the electronic device further provides relevant information related to the information identified and detected in the physical environment. In some examples, the electronic device is a head worn electronic device.

In some examples, the present disclosure provides methods for initiating processes (e.g., images processing, text recognition, saving) on views of the physical environment viewed by a user at an electronic device. The provided methods of initiating processes reduce the number of inputs required by a user to interact with the physical environment and/or with an electronic device. For example, the user does not need to take physical actions to perform contextual searching on informational content or copy informational content. Additionally or alternatively, the user does not need to take further actions (e.g., no need for button presses, touch inputs, verbal commands to a digital assistant, etc.) to instruct the electronic device to recognize, process, and/or perform operations on informational content designated by the user within the field of view of the electronic device. Accordingly, the methods described herein reduce the processor tasking and power consumption of the electronic device. Furthermore, the initiation of one or more processes through predetermined gestures results in a more intuitive, action efficient, and streamlined experience for a user.

In some examples, a method is performed at an electronic device in communication with one or more displays and a plurality of input devices including one or more motion sensors and one or more optical sensors. In some examples, the electronic device detects, via the one or more optical sensors, one or more portions of a user directed toward a first object in a physical environment. In some examples, in response to detecting that the one or more portions of a user are directed toward the first object satisfy one or more first criteria (e.g., an extended finger pointing at portion of first object), the electronic device presents, via the one or more displays, first content in association with the one or more portions of the user and the first object, wherein the first content includes informational content associated with the first object. For instance, a first extended finger directed toward (e.g., pointing at) a first object satisfies one or more first criteria, and when the first extended finger indicates one or more target words, the electronic device presents a user interface element which includes informational content related to the one or more target words.

In some examples, in accordance with a determination that the one or more portions of the user (e.g., two extended fingers) being directed toward the first object satisfies one or more second criteria, the electronic device displays, via the one or more presents, second content in association with the one or more portions of the user and the first object, wherein the first content includes informational content associated with the first object. For instance, a first extended finger and a second extended finger directed toward (e.g., pointing at) a first object satisfies one or more second criteria, and when the extended fingers indicate a string of text and/or multiple lines of text bounded by an area designated by the location of the extended fingers, the electronic device presents a user interface element which includes informational content related to the string of text and/or multiple lines of text.

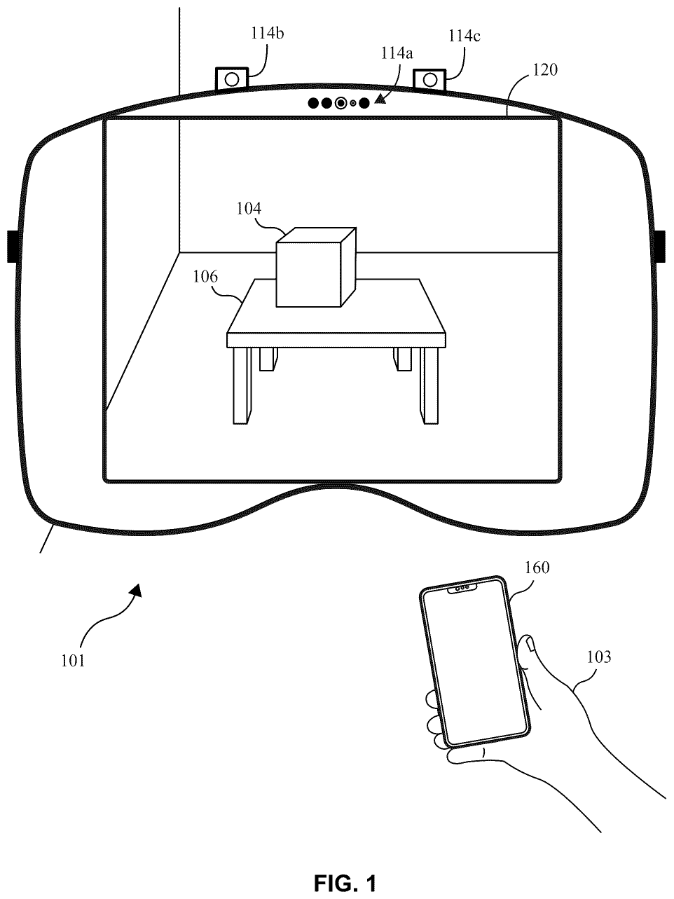

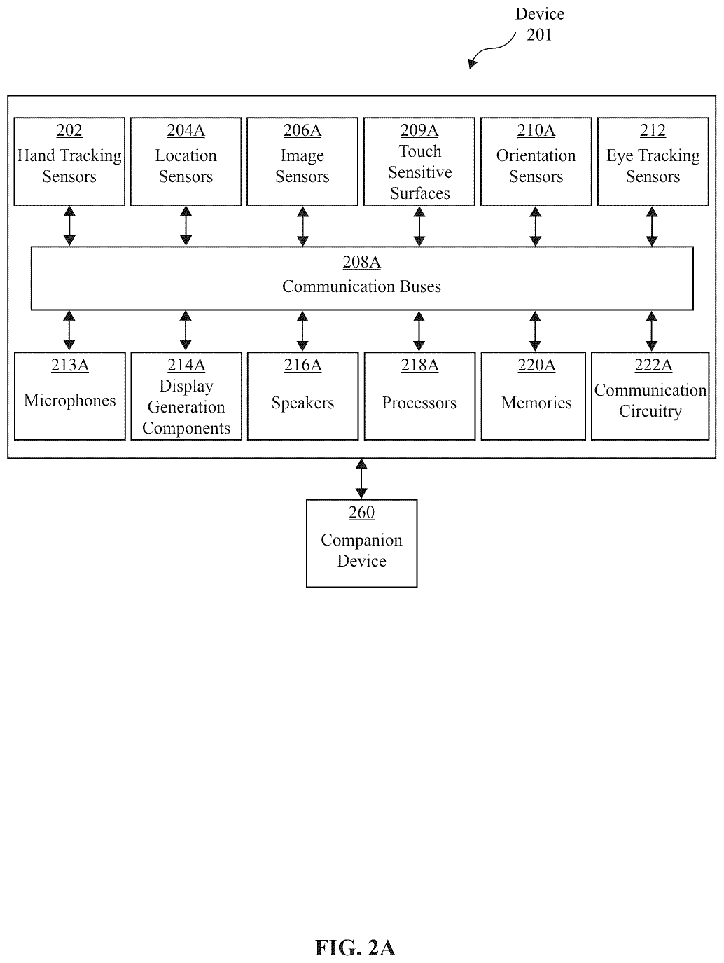

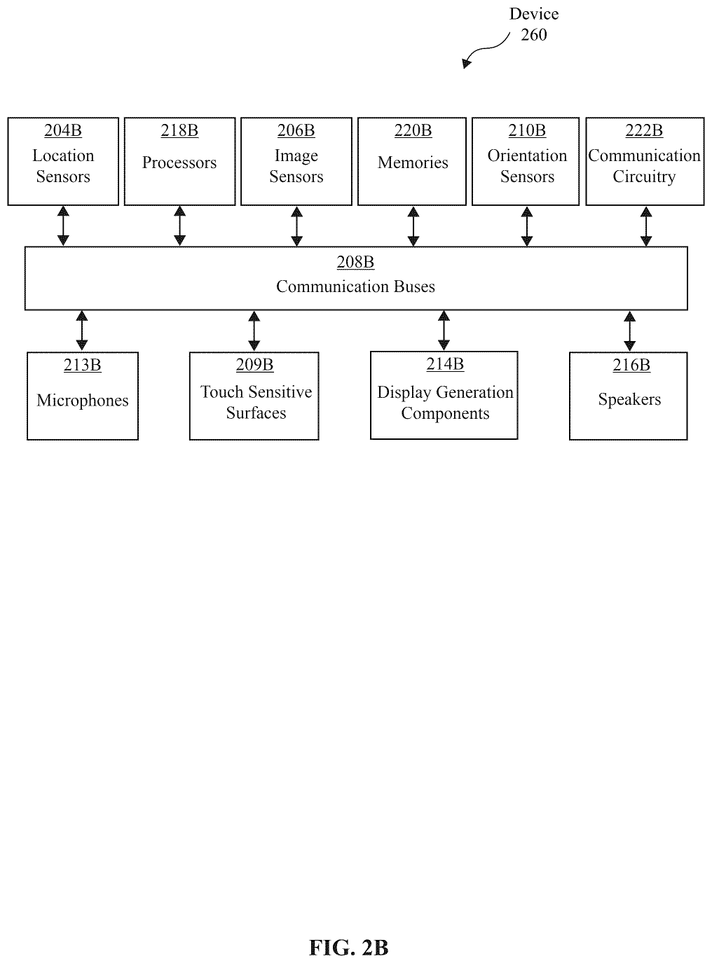

FIG. 1 illustrates an electronic device 101 presenting a three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specifies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment.

For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not).

Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now directed towards interactions with one or more virtual objects that are displayed in a three-dimensional environment presented at an electronic device (e.g., corresponding to 201 electronic devices 201 and/or 260). In some examples, while a physical environment is visible in the three-dimensional environment, the electronic device visually detects one or more regions of the physical environment, optionally regions indicated by a user through user input. In response to detecting the one or more regions of the physical environment identified through user input and/or which satisfy one or more first criteria or one or more second criteria, and in accordance with the one or more regions including first information (e.g., textual, graphical), the electronic device optionally displays one or more user interface elements which informational content related to and/or based on characteristics of the first information.

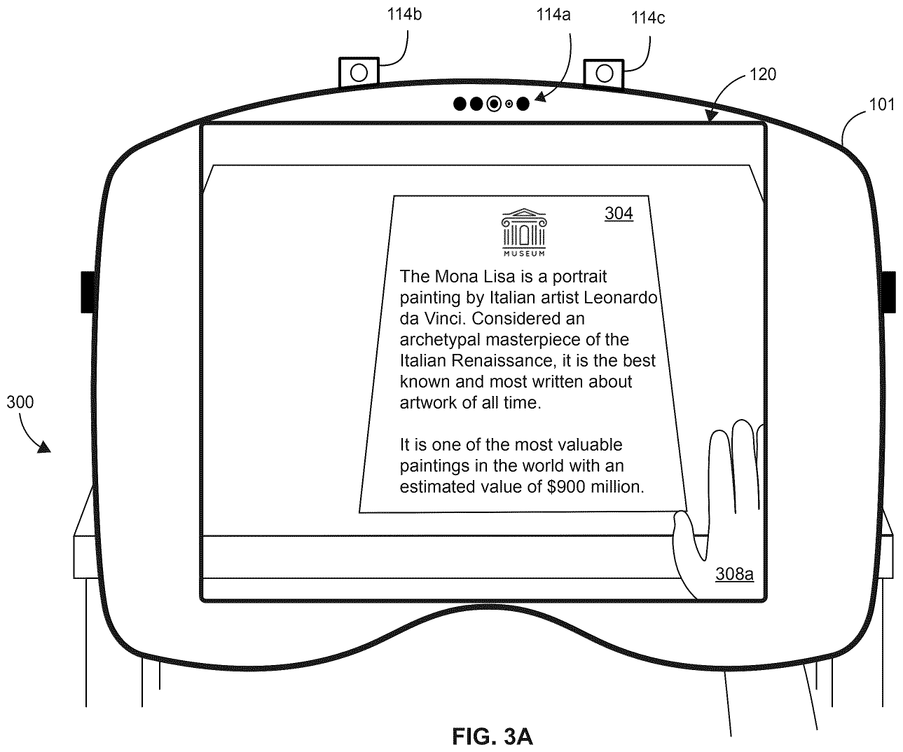

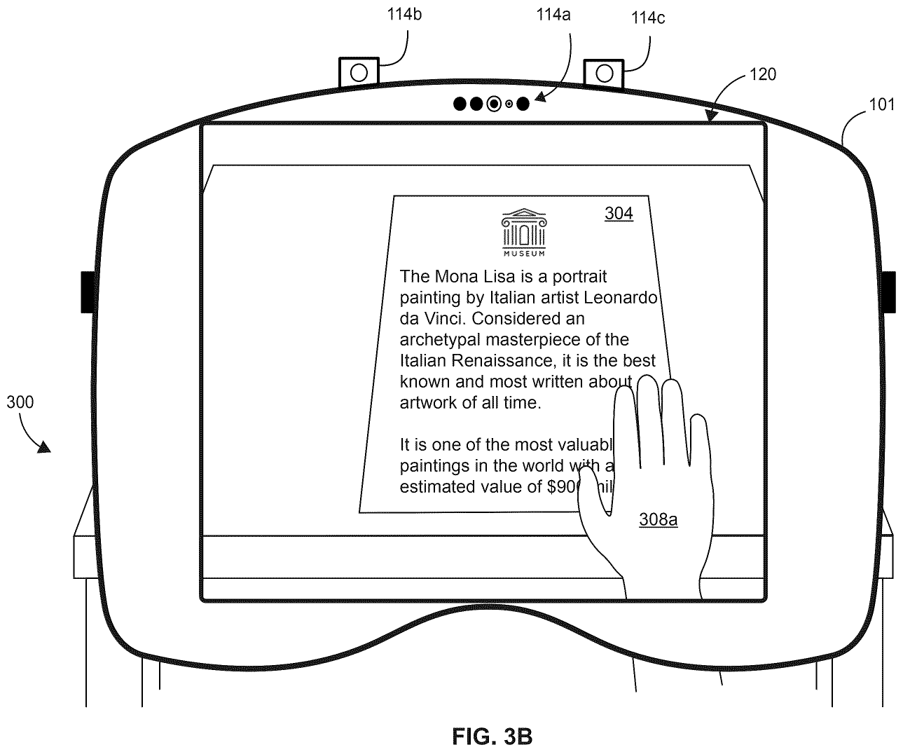

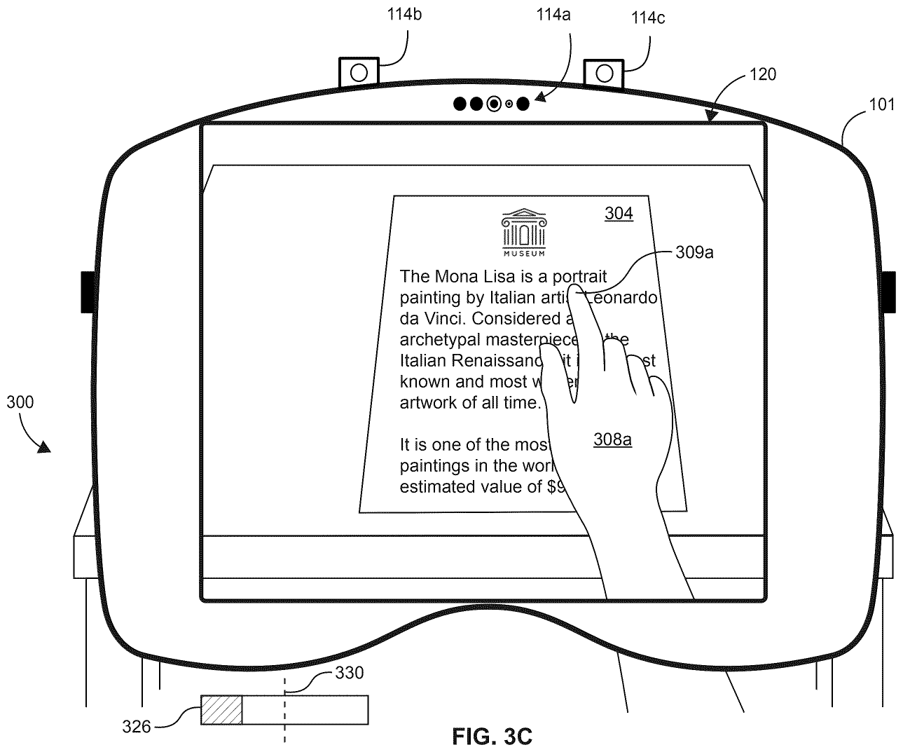

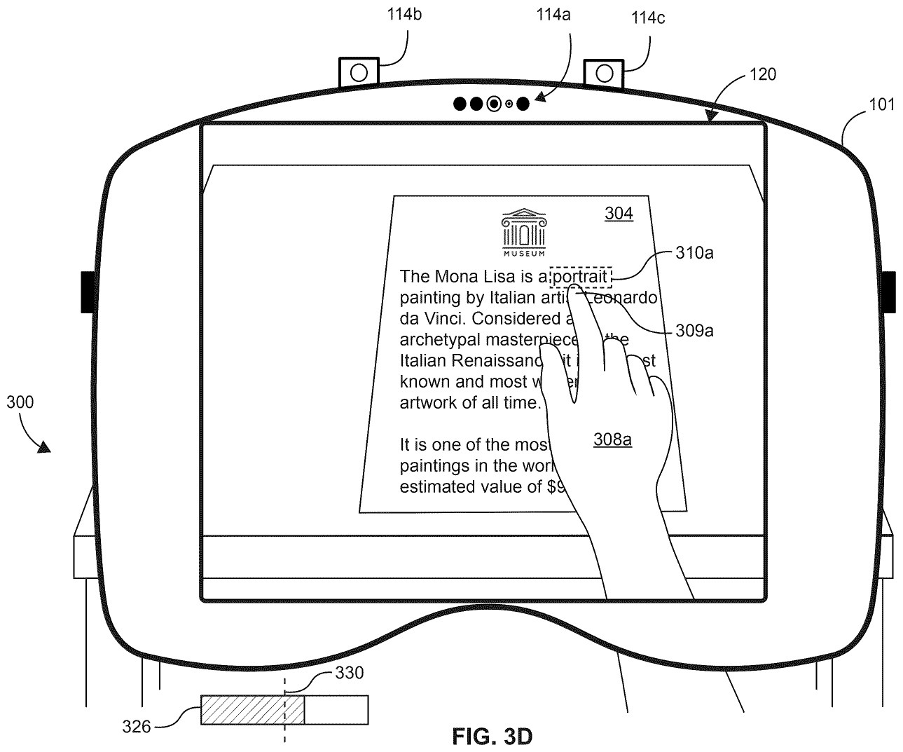

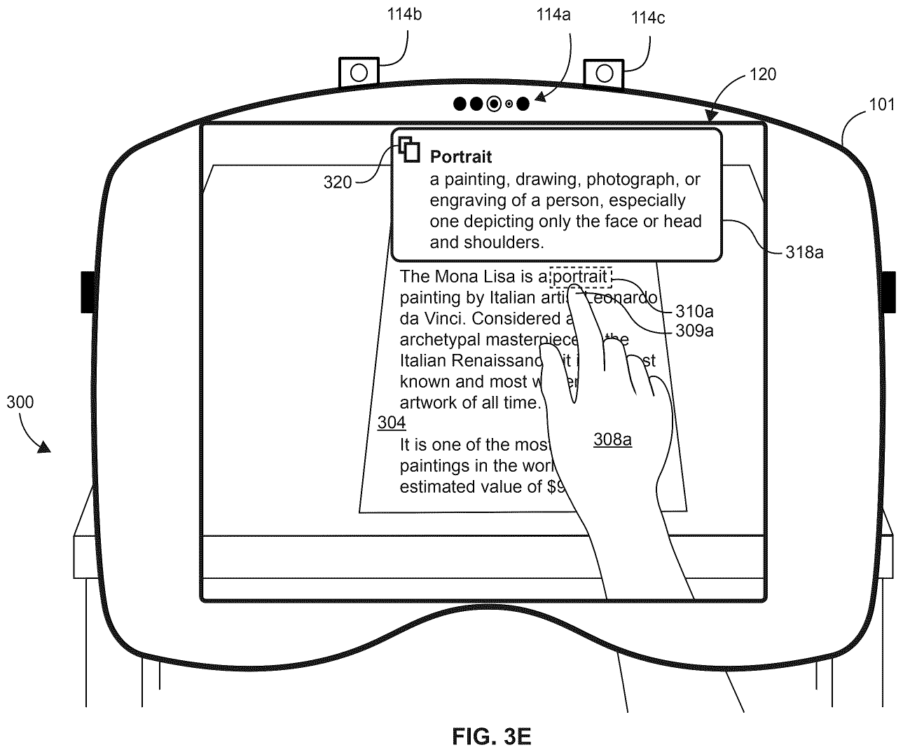

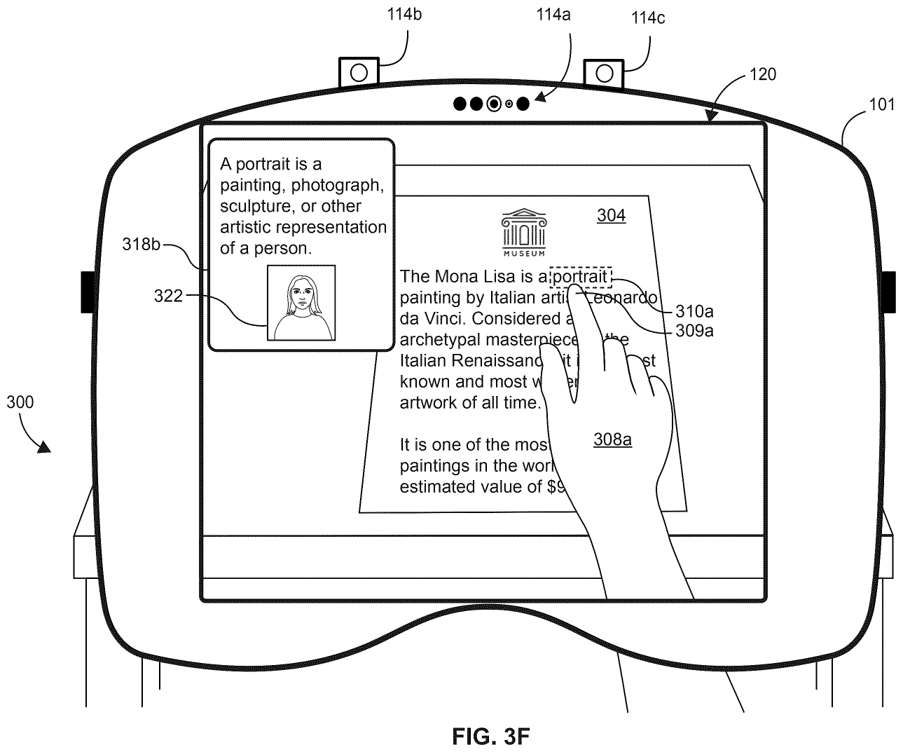

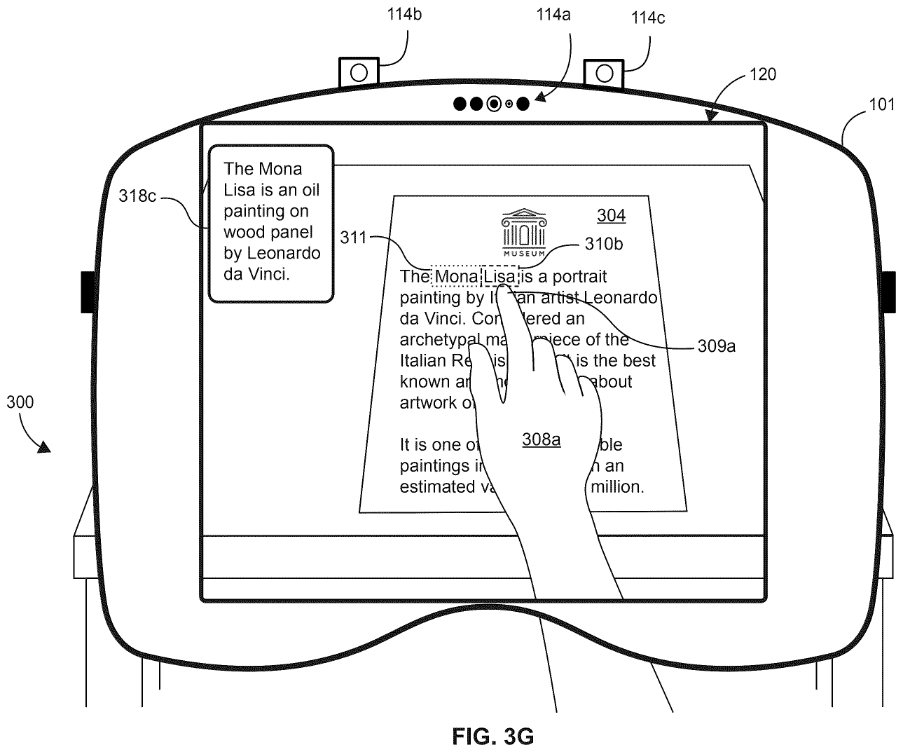

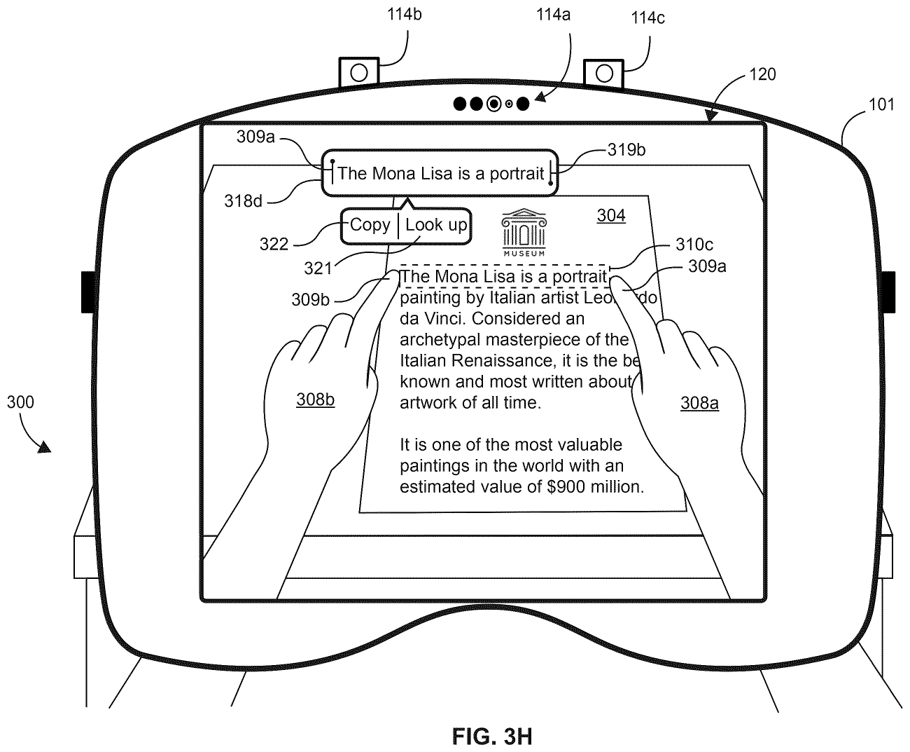

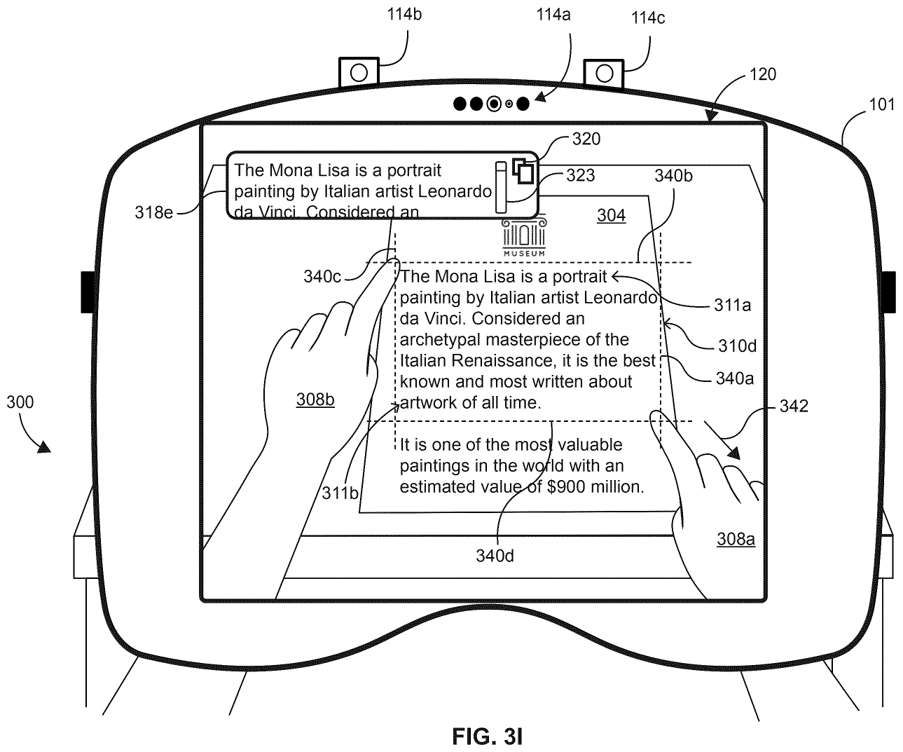

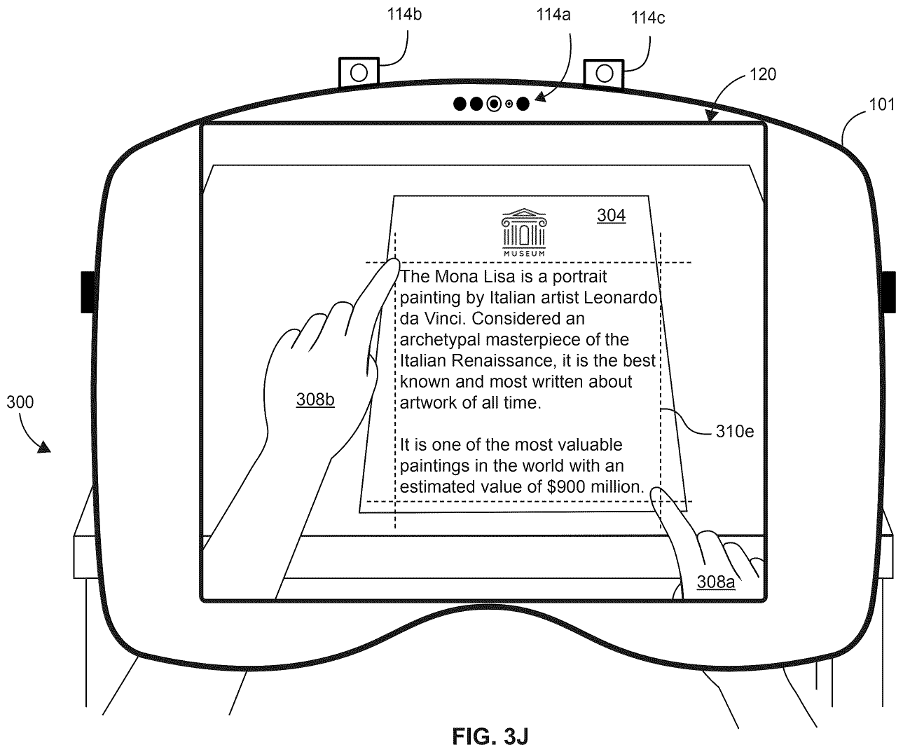

In some examples presented herein, as illustrated in FIGS. 3A-3J for instance, methods are presented which are directed toward reducing user inputs required to instruct an electronic device to recognize informational content, and/or perform operations on areas of interest of the real world (e.g., physical environment 300) as indicated by the user. The methods of the present disclosure eliminate one or more inputs typically required from a user to instruct the electronic device to perform one or more operations (e.g., Optical Character Recognition (OCR)), graphical content searching, contextual searching). For example, detecting pointing or touching objects in the real world can initiate operations that would otherwise require a user to provide multiple inputs (e.g., button presses, touch inputs, etc.) to an electronic device and/or navigating one or more user interfaces on an electronic device. Requiring one or more criteria (e.g., first criteria, second criteria) to be satisfied prior to initiating computationally expensive operations, prevents unnecessary initiation of computationally expensive operations (e.g., forgoing computationally expensive operations the one or more criteria are not satisfied). Additionally or alternatively, requiring one or more criteria (e.g., first criteria, second criteria) to be satisfied prior to initiating operations, prevents triggering operations when not intended by the user (e.g., forgoing operations the one or more criteria are not satisfied). For example, a user extending an index finger in association with (e.g., pointing at, touching, nearly touching) an object of interest optionally satisfies one or more first criteria. When the one or more first criteria are satisfied, the electronic device 101 optionally initiates one or more operations (e.g., OCR, graphical content searching, contextual searching) on the region of interest to recognize informational content (e.g., one or more target words) for subsequent functional purposes (e.g., display, save, look-up). As another example, a user using two extended index fingers in association with (e.g., pointing at, touching, nearly touching) an object of interest optionally satisfies one or more second criteria. When the one or more second criteria are satisfied, the electronic device 101 optionally initiates one or more operations (e.g., OCR, graphical content searching, contextual searching) on the region of interest to recognize informational content (e.g., string of textual information, multiple lines of textual information) for subsequent functional purposes (e.g., select, display, save, look-up). In each of the forementioned examples, the operations are performed subsequent to detecting actions satisfying one or more criteria to serve as a trigger event. By detecting inputs such as one or more portions of a user (e.g., one or more hands) performing one or more gestures (e.g., extended finger(s)) carry a far lower computational cost than recognition based operations (e.g., OCR, graphical content recognition, contextual searching), the electronic device 101 is able to perform less computationally expensive processes in order to forgo performing computationally expensive operations until the triggering criteria are satisfied indicating that the user wishes to initiate the more computationally expensive operations, thus requiring less power and conserving battery life.

In some examples of the present disclosure, the use of the teachings herein is optionally applied with contextual inputs to create actionable information. A contextual input includes for instance performing contextual searching of the indicated region of interest (e.g., first region) wherein the contextual search determines contextual information related to the region of interest. For instance, when the electronic device 101 detects a region of interest (e.g., first region) indicated by the user includes a medication or a meeting/appointment, the electronic device 101 optionally performs a contextual search to determine when related information (e.g., calendar events, times, time periods, frequency) is within a threshold distance (e.g., 5 mm, 1 cm, 5 cm, 10 cm, 25 cm). When related information is detected within a threshold distance, the electronic device 101 optionally generates actionable information (e.g., generate calendar events, generate email, fill out form fields) which the user optionally adds to the electronic device 101 or one or more alternate electronic devices. When related information is not detected within a threshold distance of the region of interest, the electronic device 101 optionally forgoes generating actionable information.

In some examples of the present disclosure, a method optionally performs operations based on a user's interaction(s) with the physical environment at an electronic device in communication with one or more displays, one or more input devices, and one or more optical sensors. For example, an electronic device, the one or more input devices, and/or the display generation component have one or more characteristics of the computer system(s), the one or more input devices, and/or the one or more display generation components 214A and/or 214B described with reference to FIG. 1-FIGS. 2A-2B. In some examples, the electronic device is configured to provide a view of a physical environment 300 (see FIG. 3A) around a user, however the examples discussed herein are not limited thereto. The examples discussed herein include, for instance, a user's interaction with an object 304 detected within the physical environment. While particular focus is drawn to regions of the physical environment 300 which include textual information, the present disclosure optionally applied to regions within the physical environment 300 lacking textual information, including graphical information, and/or including other information are within the spirit and scope of the present disclosure.

In some examples, the electronic device optionally detects, via the one or more optical sensors, one or more portions of a user directed toward an object in a physical environment. In some examples of the present disclosure, as illustrated in FIG. 3A for instance, the electronic device 101 optionally detects, via the one or more optical sensors (e.g., image sensors 114a, 114b) one or more portions of a user (e.g., first hand 308a of a user, second hand 308b of a user). The one or more optical sensors (e.g., image sensors 114a, 114b) as described herein optionally include one or more cameras, CMOS sensors, light sensors, and/or alternative sensors configured to detect variations in light and/or/imagery as related to a physical environment 300 around the electronic device 101 and/or directed toward an object 304 in the physical environment 300. In relation to the one or more portions of the user (e.g., first hand 308a of a user, second hand 308b of a user), in some examples, the electronic device 101 optionally searches and detects one or more portions of a user which optionally include one or more hands of a user, one or more fingers of a user, one or more arms or a user, one or more feet of a user, and/or one or more other portions of a user. In the forgoing examples discussed and illustrated, the one or more portions of the user include one or more hands of a user, each example optionally detects, alternate portions of a user other than the hands (308a, 308b) of a user which are illustrated. Furthermore, examples in which detection of alternate portions of a user optionally substituted for the detection of one or more hands of a user are within the spirit and scope of the present disclosure.

In some examples, the electronic device optionally detects interactions of a user with a physical environment 300. FIGS. 3A-3J illustrate an example physical environment 300 of a user wearing an electronic device 101 and interactions of the user with one or more regions and/or objects within the physical environment 300. The example physical environment 300 depicts an object 304, such as a placard in a museum for instance, wherein the placard provides information regarding a work of art (e.g., The Mona Lisa). The illustrations depict some examples of how the user optionally interacts, in conjunction with the electronic device 101, with the informational placard to gain additional information related to the information present within the physical environment, and/or optionally save informational content related to the object 304 for subsequent use. As used herein, the phrase “in conjunction with” optionally relates to co-related processes which occur prior to, in response to, simultaneously with, and/or subsequent to each other.

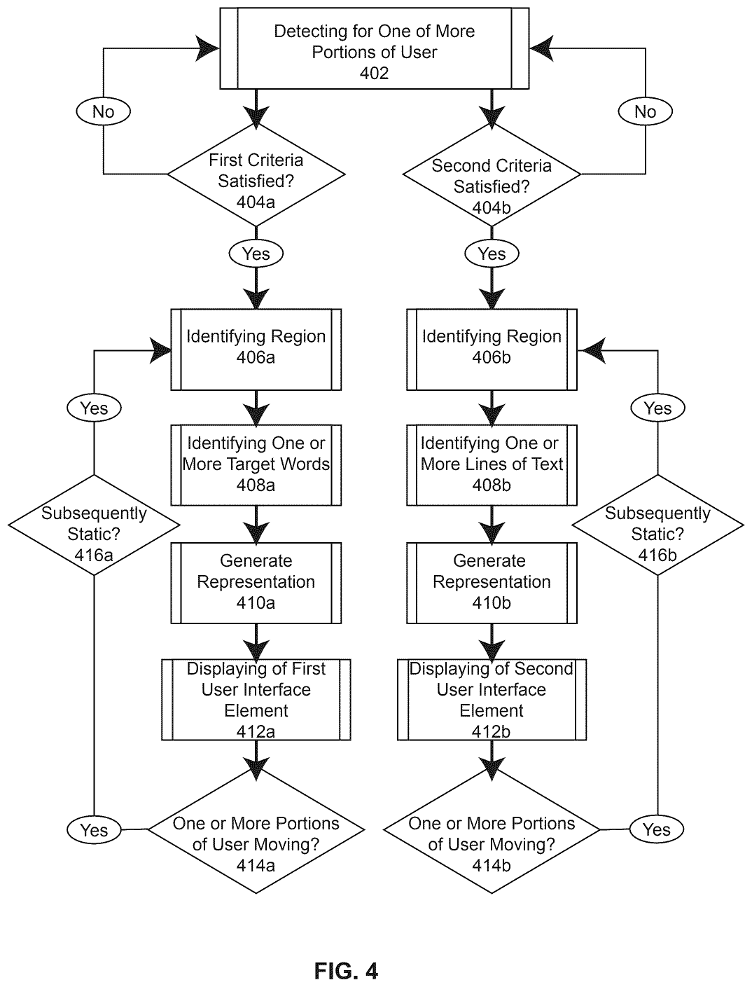

In some examples of the present disclosure, as illustrated in FIG. 4 for instance, the electronic device detects (at 402) one or more portions of a user directed toward an object in the physical environment.

In some examples, in response to detecting the one or more portions of the user, and in accordance with a determination that the one or more portions of the user being directed toward the object satisfies one or more first criteria, the electronic device displays, via the one or more displays, a first user interface element in association with the one or more portions of the user and the object, wherein the first user interface element includes informational content associated with the object. In some examples of the present disclosure, as illustrated in FIGS. 3A-3F, the electronic device 101 detects the first hand 308a of the user, via the one or more optical sensors (e.g., image sensors 114a, 114b), in association with an object 304 within the physical environment 300. When the one or more portions of the user (e.g., first hand 308a) satisfy the one or more criteria, the electronic device 101 subsequently displays, via the one or more displays 120, a first user interface element (e.g., 318a, 318b, 318c). The first user interface element is optionally associated with the one or more portions of the user (e.g., first hand 308a) and/or the portion of the object 304 which the first hand 308a is associated with. The first user interface element optionally includes informational content related the object 304 or a portion thereof.

In some examples, the one or more first criteria include a criterion that the first hand 308a of the user is detected to be associated with a first region 310a of the object 304. In some examples of the present disclosure, the one or more first criteria include a criterion that only the first hand 308a of the user is detected to be associated with a first region 310a of the object 304. In some examples of the present disclosure, the one or more first criteria include a criterion that the first hand 308a of the user is static in relation to the object 304. In some examples of the present disclosure, the one or more first criteria include a criterion that the first hand 308a of the user is detected to be in association with a region (e.g., 310a, 310b) of the object 304 within the physical environment 300.

In some examples, the one or more first criteria optionally include a criterion that is satisfied when the electronic device 101 detects that the user's first hand 308a is static and/or exhibiting movement below a movement threshold, (e.g., less than a displacement threshold, less than a velocity threshold, and/or less than an acceleration threshold) in relation to a position in the physical environment (e.g., first region 310a) within a predetermined time period. Additionally or alternatively, in some examples the one or more first criteria optionally include a criterion that is satisfied when the electronic device 101 detects that the user's first hand 308a exhibits movement (e.g., velocity, acceleration) which is below a threshold (e.g., maximum threshold of velocity, maximum threshold of acceleration) during a predetermined time period.

Additionally or alternatively, in some examples, when the electronic device 101 detects that the user's hand 308a is not static and/or exhibiting movement exceeding a movement threshold (e.g., greater than a displacement threshold, greater than a velocity threshold, and/or greater than an acceleration threshold in a direction away from the first region 310a), the electronic device 101 determines that the one or more first criteria have not been satisfied.

Examples of a displacement threshold include virtual distance based thresholds (e.g., 0 pixels, 1 pixel, 5 pixels, 10 pixels, 25 pixels, 50 pixels, 100 pixels, and/or more than 100 pixels) and/or real-world based distances (e.g., physical distances) including, but are not limited to, distances of: 0 mm (e.g., occluding, touching, nearly touching), 1 mm, 5 mm, 25 mm, 100 mm, 50 cm, 1 m, 3 m, or more than 3 m, etc. Examples of a predetermined time period include: less than 50 milliseconds, 50 milliseconds, 150 milliseconds, 0.5 seconds, 1 second, etc. Examples of a velocity threshold include virtual velocity based thresholds (e.g., 0 pixels/s, 1 pixel/s, 5 pixels/s, 10 pixels/s, 25 pixels/s, 50 pixels/s, 100 pixels/s, and/or more than 100 pixels/s) and/or real-world based velocities (e.g., physical velocities) including, but are not limited to, velocities of: 0 mm/s, 1 mm/s, 5 mm/s, 25 mm/s, 100 mm/s, 50 cm/s, 1 m/s, 3 m/s, or more than 3m/s, etc.

Examples of an acceleration threshold include virtual distance based accelerations (e.g., 0 pixels/s², 1 pixel/s², 5 pixels/s², 10 pixels/s², 25 pixels/s², 50 pixels/s², 100 pixels/s², and/or more than 100 pixels/s²) and/or real-world based accelerations (e.g., physical velocities) including, but are not limited to, accelerations of: 0 mm/s², 1 mm/s², 5 mm/s², 25 mm/s², 100 mm/s², 50 cm/s², 1 m/s², 3 m/s², or more than 3 m/s², etc. Examples of a velocity threshold discussed herein include, but are not limited to: 5 mm/s, 1 cm/s, 10 cm/s, 50 cm/s, 1m/s, etc.

In some examples, the one or more first criteria comprise a criterion that is satisfied when a portion of a user (e.g., a finger) physically contacts an object 304 in the physical environment 300. For instance, when a user's finger comes in contact (e.g., occluding, nearly touching such as within a threshold distance, touching) with one or more words appearing on an object 304 (e.g., a description of an artwork), the criterion related to the physical contact with an object is satisfied. Following the determination that the one or more second criteria are satisfied, the electronic device performs subsequent actions directed at the analysis of a region of interest associated with the one or more first portions of the user which satisfy the one or more first criteria. The term “nearly touching” as related to one or more portions of a user (e.g., a user's first finger 309a) in relation to a portion of the physical environment (e.g., object 304) includes a proximity threshold. For example, when the user's first finger 309a is detected to be within a proximity threshold of a first object 304, the user's first finger 309a is determined by the electronic device 101 to be in contact with the first object 304. Examples of a proximity threshold include virtual distance based thresholds (e.g., 0 pixels, 1 pixel, 5 pixels, 10 pixels, 25 pixels, 50 pixels, 100 pixels, and/or more than 100 pixels, etc.), and/or physical distances (e.g., 0 mm, 1 mm, 5 mm, 25 mm, more than 25 mm, etc.).

As used herein, and as illustrated in FIG. 3A-3J for instance, “associated with” and the “association of” as related to a portion of a user refers to a portion of a user which is in proximity of (e.g., within a threshold distance of) an object or region (e.g., 310a, 310b, 310c, 310d, 310e) within the physical environment (e.g., object 304), and/or directed toward (e.g., a hand gesture) an area corresponding with the object 304 or region (e.g., 310a, 310b, 310c, 310d, 310e) within the physical environment 300. A threshold distance, in some examples of the present disclosure, relates to a physical threshold distance between a portion of the user (e.g., first hand 308a, second hand 308b) and an object or location as it exists within the physical environment. Example physical threshold distances include, but are not limited to, distances of: 0 mm (e.g., occluding, touching, nearly touching), 1 mm, 5 mm, 25 mm, 1 cm, 50 cm, 1 m, 3 m, or more than 3 m. Furthermore, a threshold distance, in some examples of the present disclosure, optionally relates to a virtual threshold distance between the portion of the user (e.g., user's hand 308a, 308b) and an object as displayed on the one or more displays 120. Example virtual threshold distances include, but are not limited to, distances of: 0 pixels, 1 pixel, 5 pixels, 10 pixels, 25 pixels, 50 pixels, 100 pixels, and/or more than 100 pixels. Furthermore, in some examples, when the user's hand 308 visually overlaps and/or occludes an object as displayed on the one or more displays 120, the user's hand 308 is optionally determined to be within the threshold distance.

In some examples of the present disclosure, a method 400 is performed by the electronic device, as illustrated in FIG. 4 for instance, wherein the electronic device determines whether or not one or more first criteria have been satisfied (at 404a). When the electronic device determines that the one or more first criteria have been satisfied, the electronic device optionally performs one or more subsequent processes. When the electronic device does not determine that the one or more first criteria have been satisfied, the electronic device optionally forgoes performing subsequent operations and/or resumes detecting for one or more portions of the user (at 402). When the electronic device determines that the one or more portions of the user satisfy one or more first criteria, the electronic device subsequently displays a first user interface element (at 412a) in association with the one or more portions of the user which satisfy the one or more first criteria. Additionally or alternatively, when the electronic device determines that the one or more portions of the user satisfy one or more first criteria, the electronic device outputs audio from one or more speakers, presenting audible informational content, in association with the one or more portions of the user which satisfy the one or more first criteria. Additionally or alternatively, when the electronic device determines that the one or more portions of the user satisfy one or more first criteria, the electronic device outputs a haptic from one or more haptic generators of the electronic device (not shown) in association with the one or more portions of the user which satisfy the one or more first criteria.

In some examples of the present disclosure, as illustrated in FIGS. 3H-3J for instance, the electronic device 101 determines whether there are multiple portions of a user (e.g., a user's first hand 308a and a user's second hand 308b) detected in association with an object within the physical environment 300. For instance, shown in FIGS. 3H-3J, a first extended finger 309a and a second extended finger 309b are detected as associated with (e.g., pointing at, touching, occluding, nearly touching) a first object 304 (e.g., museum placard). In some examples the electronic device 101 optionally detects the multiple extended fingers of the user for instance as related to a string of textual information (FIG. 3H). When the fingers are detected as being associated with a single line of textual information (e.g., first region 310c at FIG. 3H) the electronic device 101 determines the first region 310c to include the textual information between the first extended finger 309a and the second extended finger 309b. Furthermore, in some examples, the electronic device 101 detects movements of the extended fingers as user input to modify the boundary of the first region 310c, thus adjusting the textual information within the first region 310c.

Additionally or alternatively, when the fingers are detected as being associated with multiple lines of text as shown in FIG. 3I for instance, the electronic device optionally determines the first region (e.g., 310d) based on the locations of the first extended finger 309a and the second extended finger 309b. For instance, the extended fingers optionally define opposite corners of a rectangular region as illustrated in FIG. 3I. Furthermore, in some examples the electronic device 101 detects movements of the extended fingers as user input to modify the boundary of the first region 310d and identifying a second region 310e (at FIG. 3J), thus adjusting the textual information of interest.

In some examples of the present disclosure, in accordance with a determination that the one or more portions of the user being directed toward the object satisfies one or more second criteria, different from the one or more first criteria, the electronic device optionally displays, via the one or more displays, a second user interface element in association with the one or more portions of the user and the object. In some examples of the present disclosure, as illustrated in FIGS. 3H-3J for instance, the one or more second criteria include a criterion that the one or more portions of the user includes a first portion of the user (e.g., first hand 308a) and a second portion of the user (e.g., second hand 308b) which optionally appear within the field of view of the electronic device 101. The one or more portions of the user are optionally associated with and/or directed toward an object 304, a portion of the object 304, or a region (e.g., 310c, 310d, 310e) of the physical environment 300. In some examples, the one or more second criteria include a criterion that is satisfied when the user's first hand 308a and the user's second hand 308b appear within the field of view of the electronic device 101 simultaneously. When the detected first hand 308a and second hand 308b of the user are determined to satisfy the one or more second criteria, the electronic device 101 optionally displays, via the one or more displays (e.g., display 120), a second user interface element. The second user interface element optionally includes informational content related to the object 304, a portion of the object 304, or a region of the physical environment 300 which the first hand 308a and the second hand 308b of the user are determined to be associated with.

In some examples of the present disclosure, the second user interface element includes informational content related to the position of the first portion of the user (e.g., first hand 308a), the second portion of the user (e.g., second hand 308b), and the object 304. In some examples, the first portion of the user and the second portion of the user optionally designate a region (e.g., 310c, 310d, 310e) wherein the region includes textual or graphical content.

In some examples of the present disclosure, a method 400 is performed by the electronic device, as illustrated in FIG. 4 for instance, wherein the electronic device determines whether or not one or more second criteria have been satisfied (at 404b). When the electronic device determines that the one or more second criteria have been satisfied, the electronic device optionally performs one or more subsequent processes. When the electronic device does not determine that the one or more second criteria have been satisfied, the electronic device optionally resumes detecting for one or more portions of the user (at 402). When the electronic device determines that the one or more portions of the user satisfy one or more second criteria, the electronic device subsequently displays a second user interface element (at 412b) in association with the one or more portions of the user which satisfy the one or more second criteria. Additionally or alternatively, when the electronic device determines that the one or more portions of the user satisfy one or more second criteria, the electronic device outputs audio from one or more speakers, presenting audible informational content, in association with the one or more portions of the user which satisfy the one or more second criteria and/or outputs a haptic from one or more haptic generators of the electronic device (not shown) in association with the one or more portions of the user which satisfy the one or more second criteria.

In some examples, the one or more portions of the object optionally comprise textual information. In some examples of the present disclosure, as shown in FIGS. 3A-3J for instance, the one or more portions (e.g., region 310a, 310b, 310c, 310d, 310e) are determined to include textual information. In some examples, following the detection of the one or more portions of the user being directed toward an object 304, wherein the one or more portions of the user satisfy one or more first criteria or one or more second criteria, the electronic device 101 optionally performs image processing operations on one or more views (e.g., live view, one or more optical captures, one or more captured images) to determine when informational content (e.g., textual information, graphical information) is present in the region designated by the one or more portions of the user which are directed toward the object.

In some examples of the present disclosure, as illustrated in FIG. 4 for instance, in conjunction with determining that the one or more first criteria have been satisfied, the electronic device identifies a first region (at 406a, 406b). In some examples, in conjunction with identifying a first region (at 406a, 406b) the electronic device identifies one or more target words (at 408a, 408b) associated with the one or more portions of the user which satisfy the one or more first criteria. In some examples, identifying the one or more target words (at 408a, 408b) further comprises determining if the first region comprises textual information.

In some examples, the one or more first criteria optionally include a criterion that is satisfied when the one or more portions of the user are detected as performing a first gesture. In some examples of the present disclosure, as illustrated in FIGS. 3C-3D for instance, the one or more first criteria include a criterion that is satisfied when the one or more portions of the user (e.g., first hand 308a) is detected performing a first gesture (e.g., first extended finger 309a). In some examples, the first extended finger 309a is detected to be associated with textual information (e.g., one or more target words) within a first region 310a indicated by the first extended finger 309a.

In some examples of the present disclosure, the one or more first criteria include a criterion that is satisfied when the one or more portions of a user (e.g., first hand 308a, first extended finger 309a) are detected in association with textual information within a first region 310a for at least a threshold time period. For example, when the one or more portions of a user are associated with the first region 310a for a first time period 326, less than a threshold time period 330 (at FIG. 3C), the electronic device 101 optionally forgoes performing operations on the one or more optical captures of the physical environment. Additionally or alternatively, when the one or more portions of a user are associated with the first region 310a for a first time period 326 which is greater than a threshold time period 330 (at FIG. 3D), the electronic device 101 optionally performs one or more operations on the one or more optical a captures of the physical environment. Examples of a threshold time period include: less than 50 milliseconds, 50 milliseconds, 150 milliseconds, 0.5 seconds, 1 second, etc.

In some examples of the present disclosure, as illustrated in FIG. 4 for instance, detecting for one or more portions of a user (at 402) includes determining when the one or more portions of a user satisfies a criterion of the one or more first criteria, which is satisfied when the one or more portions of a user is performing a first gesture (e.g., a first extended finger).

In some examples, in response to satisfying the one or more first criteria, and in accordance with the first gesture being associated with one or more target words of the textual information when the one or more first criteria are satisfied, the electronic device optionally displays the first user interface element in association with the one or more portions of the user and the object, wherein the electronic device performs one or more image processing algorithms on the one or more target words to generate a representation of the one or more target words. In some examples of the present disclosure, as illustrated in FIGS. 3D-3F for instance, when the one or more first criteria are satisfied, and the first gesture (e.g., first extended finger 309a) is detected in association with one or more target words within the first region 310a indicated by the first gesture, the electronic device optionally displays a first user interface element. In accordance with (e.g., prior to, simultaneously with, subsequent to) displaying the first user interface element, the electronic device 101 performs one or more image processing algorithms on the one or more target words within the first region 310a to generate a representation of the one or more target words. The one or more image processing algorithms optionally include Optical Character Recognition (OCR) algorithms which are configured to recognize the textual information for subsequent operations such as displaying, translating, copying, saving, and/or other subsequent processes. The representation of the one or more target words optionally includes the translation of the one or more target words into preferred language designated by a user to the electronic device 101. Furthermore, the representation of the one or more target words includes representing the one or more target words with a graphical representation. For instance, a generated representation of the word “yellow” optionally includes a visual representation of the color yellow, or a generated representation of the word “giraffe” optionally includes an image of a giraffe.

While some examples shown herein include the use of an extended index finger (e.g., 309a) of a user's first hand 308a in an extended position, alternate examples wherein the one or more first criteria include a criterion that is satisfied when a thumb, middle finger, ring finger, pinkie finger, or combination thereof are in an extended position, are within the spirit and scope of the present disclosure. Furthermore, examples shown herein include a first extended index finger (e.g., 309a) and a second extended index finger (e.g., 309b) as examples demonstrating one or more second criteria being satisfied. Alternate examples wherein the one or more second criteria are satisfied by one or more gestures performed by a thumb, middle finger, ring finger, pinkie finger, or combination thereof, are within the spirit and scope of the present disclosure. Furthermore, alternate examples in which the one or more second criteria are satisfied when the electronic device 101 detects a first gesture and a second gesture performed by a single hand of a user, are within the spirit and scope of the present disclosure. Furthermore, in some examples, the user optionally programs the electronic device 101 to recognize a custom gesture in the event the user is unable to perform one or more predetermined gestures.

In some examples, the electronic device 101 saves the representation of one or more target words to memory 220 of the electronic device. In some examples of the present disclosure, subsequent to or simultaneously with the initiating image processing (e.g., OCR), the electronic device 101 saves the string of textual information, such as found in the within the first region (e.g., 310a, 310b) to memory 220 (e.g., in FIG. 2), such as short-term memory storage (e.g., copy indicated at 320), wherein the user is able to export (e.g., paste) the representation of the string of textual information into alternate applications/files on the electronic device 101, or into applications/files on alternate electronic devices.

In some examples of the present disclosure, as illustrated in FIG. 4 for instance, the electronic device generates a representation of the one or more target words (at 410a) such as through the use of one or more image processing algorithms (e.g., OCR, graphical content recognition). Image processing as discussed within the present disclosure includes applying image processing algorithms to a displayed view (e.g., via the one or more displays 120 at FIGS. 3A-3J), applying images processing to one or more optical captures (e.g., one or more images), and/or regions of the physical environment 300 as detected through the om optical sensors (e.g., 114b, 114c).

In some examples of the present disclosure, the electronic device optionally displays, via the one or more displays, the representation of the one or more target words in the first user interface element. In some examples of the present disclosure, as illustrated in FIG. 3E for instance, subsequent to generating a representation of the one or more target words, the electronic device 101 displays, via the one or more displays 120, informational content related to the one or more target words identified in the first region 310a within a first user interface element 318a. The first user interface element optionally includes the generated representation of the one or more target words from the first region (e.g., 310a) in the first user interface element 318a.

In some examples of the present disclosure, as illustrated in FIG. 4 for instance, in conjunction with generating a representation (at 410a) the electronic device optionally displays a first user interface element (at 412a) wherein the first user interface element optionally includes the representation of the one or more target words generated (at 410a).

In some examples, the informational content displayed in the first user interface element is optionally associated with the one or more target words. In some examples of the present disclosure, as illustrated in FIGS. 3E-3F for instance, the electronic device 101 displays informational content including and/or associated with the one or more target words identified in the first region 310a. The informational content displayed, via the one or more displays 120, in the first user interface element optionally includes textual information, graphical information, and/or generated information associated with the one or more target words.

In some examples of the present disclosure, as illustrated in FIG. 4 for instance, the displaying of the first user interface element (at 412a) optionally includes displaying a definition of the one or more target words, displaying informational content related to the one or more target words based on the geographic location of the electronic device, and/or generating an encyclopedic description of the one or more target words.

In some examples, subsequent to determining that the one or more first criteria are satisfied (at 404a), such as after displaying the first user interface element (at 412a), when the electronic device detects that the one or more portions of a user are moving (at 414a), the electronic device optionally reverts to identifying the region (at 406a) associated with the one or more portions of a user. While detecting whether the one or more portions of a user are moving (at 414a) is described and illustrated as occurring subsequent to displaying the first user interface element (at 412a), detecting of the movement of the one or more portions of a user (at 414a) is optionally conducted prior to, simultaneously with, and/or subsequent to any operation of the method 400 subsequent to determining whether the one or more first criteria have been satisfied (at 404a). In some examples, subsequent to the detection of one or more first portions of a user of the user as moving (at 414a) in relation to the physical environment, the electronic device optionally forgoes subsequent operations until the one or more portions of a user of the user are detected to be subsequently static (at 416a).

In some examples, the informational content associated with the object optionally includes a definition of the one or target more words of the textual information. In some examples of the present disclosure, as illustrated in FIGS. 3E-3F for instance, the informational content displayed in the first user interface element 318a optionally includes a definition of the textual information (e.g., one or more target words) identified in the first region 310a. The definition as discussed herein can be optionally retrieved and/or formulated from a published dictionary, crowd-sourced dictionary, and/or through Artificial Intelligence (AI) algorithms.

While examples discussed and illustrated herein include the electronic device 101 displaying informational content (e.g., definition of one or more target words, encyclopedic entry, graphical representation) in a first user interface element in relation a first region (e.g., 310a) of the physical environment 300 following the one or more portions of the user satisfying the one or more first criteria, alternate examples wherein the electronic device displays informational content following the one or more portions of the user satisfying one or more second criteria are within the spirit and scope of the present disclosure. In some examples, the encyclopedic entry displayed in the first user interface element includes an image related to the one or more target words of the textual information.

In some examples, the electronic device optionally determines a geographic location of the electronic device, and displays, via the one or more displays a definition associated with the textual information that is formulated based on the geographic location of the electronic device. In some examples of the present disclosure, following the determination that the one or more portions of the user (e.g., first hand 308a) satisfy one or more first criteria, the electronic device 101 subsequently, or simultaneously, detects the geographic location of the electronic device 101, and displays a definition of the textual information that is formulated based on the geographic location of the electronic device 101. In some examples, the geographic location of the electronic device is determined using one or more location sensors 204 (e.g., GPS sensors). Additionally or alternatively, the location of the electronic device 101 is optionally determined using communication circuitry 222 (e.g., Bluetooth®, Wi-Fi®), location information associated with a local or extended network, and/or crowd-sourced location information.

In some examples of the present disclosure, generating a representation (at 410) optionally includes detecting the geographic location of the electronic device, prior to displaying of a first user interface element (at 412a).

In some examples, the informational content associated with the object includes an encyclopedic entry. In some examples, as illustrated in FIG. 3F for instance, the informational content displayed by the electronic device 101 in the first user interface element 318b includes an encyclopedic description of the first information. In some examples of the present disclosure, as illustrated in FIG. 3F, the informational content displayed within the first user interface element 318b comprises an encyclopedic description of one or more target words found within the first region 310a indicated by a user's first hand 308a, and optionally by an extended index finger (e.g., 309a) of a user's hand.

In some examples, the one or more image processing algorithms optionally include optical character recognition, and/or a context searching algorithm configured to determine the presence of one or more related words in the textual information.

In some examples of the present disclosure, the electronic device 101 performs one or more OCR processes on the informational content (e.g., one or more target words) within the identified first region 310b as illustrated in FIG. 3G for instance. Furthermore, in some examples, the electronic device 101 performs a process to recognize related words adjacent to the first region 310b. For instance, when the user's index finger 309 indicated a first region 310b which bounds the term “Lisa” as shown, initiating image processing (e.g., OCR) optionally includes a context searching process to identify contextually related words, such as “Mona” beside “Lisa”. Accordingly, in such an event, the electronic device 101 displays, via the one or more displays 120, a first user interface element 318c which includes an encyclopedic description of the terms “Mona Lisa” such as shown in FIG. 3G for instance. In some examples of the present disclosure, an encyclopedic description is optionally AI generated. An encyclopedic description of the contextually correlated terms optionally provides a user a more in-depth and relevant information pertaining to the informational content detected in the first region 310b wherein, for instance, a user more likely would like to learn about the “Mona Lisa” as opposed to a dictionary entry about “Lisa” as a generic name.

In some examples of the present disclosure, as illustrated in FIG. 4 for instance, identifying one or more target words (at 408a) includes performing image processing algorithms on the first region such as OCR and/or a context searching algorithm configured to determine the presence of one or more related words within the textual information which are associated with and/or adjacent to the one or more target words.

In some examples, while the electronic device performs the context searching algorithm, in accordance with a determination that one or more related words are adjacent to the one or more target words, the electronic device optionally displays, via the one or more displays, informational content in the first user interface element associated with a phrase comprising the one or more target words and the one or more related words. In some examples of the present disclosure, the electronic device 101 initiates a context searching process to identify contextually related and/or relevant words in proximity to the one or more target words indicated within the first region 310b, such as illustrated in FIG. 3G. In some examples, the electronic device 101 optionally determines that the one or more target words and the one or more related words are related to a phrase within the textual information and/or a commonly known phrase. In some examples, following the context searching process, the electronic device 101 optionally generates and/or displays, via the one or more displays 120, informational content within the first user interface element 318c which is related to a phrase which includes the one or more target words and one or more related words such as found in a second region 311 which is related and optionally adjacent to the first region 310b.

In some examples of the present disclosure, as illustrated in FIG. 4 for instance, in conjunction with identifying the one or more related words (at 408a), the electronic device displays a first user interface element (at 412a) which optionally includes informational content related to the one or more target words and/or the one or more related words.

In some examples, wherein the electronic device optionally displays information content associated with the phrase further comprises displaying, via the one or more displays, a definition, within the first user interface element, associated with the phrase comprising the one or more target words and the one or more related words. Additionally or alternatively, in conjunction with (e.g., simultaneously, subsequently to) identifying the one or more related words within a second region 311 which are related to and optionally adjacent to the one or more target words within the first region 310b, the electronic device 101 optionally determines whether the one or more target words and the one or more related words are related to a phrase. In accordance with determining that the one or more target words and the one or more related words are part of a phrase, the electronic device 101 optionally generates a definition related to the phrase and displays, via the one or more displays 120, the definition related to the phrase.

In some examples of the present disclosure, following a determination that the one or more first criteria are satisfied, and in conjunction with performing an image processing operation, the electronic device 101 optionally detects a geographic location of the electronic device 101, and subsequently generates a definition (e.g., colloquial meaning) of the phrase based on the regional context as related to the location of the electronic device 101. In some examples, the definition of the phrase optionally defines textual information which is detected as including a foreign language and/or slang. For instance, in accordance with the first region 310b shown in FIG. 3G including textual information on an object 304 (e.g., a flyer) including the phrase “How yinz doing?” and the electronic device 101 detects the location of the electronic device within Pittsburgh, Pennsylvania, the electronic device optionally displays a definition, such as “How are you all doing?”, indicating a general accepted meaning of the phrase within the context of the geographic location of the electronic device 101. Additionally or alternatively, in the event that the electronic device 101 detects the location of the electronic device 101 as located in Philadelphia, Pennsylvania, the definition of the phrase “How yinz doing?”, a phrase common to the Pittsburgh area, is optionally provided in relation to colloquialisms in Philadelphia, wherein the definition displayed optionally comprises the phrase “How youse doing?”, a phrase common to the Philadelphia area.

In some examples of the present disclosure, the electronic device 101 optionally generates an encyclopedic entry related to the phrase which optionally includes a definition of the phrase, a colloquial meaning of the phrase, the history of the phrase, and/or imagery related to the phrase.

In some examples, the one or more second criteria optionally include a criterion that is satisfied when the one or more portions of the user include a first hand performing a first gesture, and a second hand, different than the first hand, performing a second gesture. In some examples of the present disclosure, as illustrated in FIGS. 3H-3J for instance, the one or more second criteria are optionally satisfied when the electronic device 101 detects a first portion of the user (e.g., first hand 308a) performing a first gesture, and a second portion of the user (e.g., second hand 308b) performing a second gesture directed toward and/or associated with an object 304, a portion of an object 304, and/or a region within the physical environment 300. In some examples, the one or more second criteria are optionally satisfied in accordance with the one or more first portions of the user and the one or more second portions of the user being within the field of view of the electronic device 101 and/or displayed via the one or more displays 120 of the electronic device 101.

In some examples of the present disclosure, a method 400 is performed by the electronic device, as illustrated in FIG. 4 for instance, wherein the electronic device determines whether or not one or more second criteria have been satisfied (at 404b). When the electronic device determines that the one or more second criteria have been satisfied (at 404b), the electronic device optionally performs one or more subsequent processes. When the electronic device does not determine that the one or more second criteria have been satisfied, the electronic device optionally resumes detecting for one or more portions of the user (at 402). When the electronic device determines that the one or more portions of the user satisfy one or more second criteria, the electronic device subsequently displays a second user interface element (at 412b) in association with the one or more portions of the user which satisfy the one or more second criteria.

In some examples of the present disclosure, as illustrated in FIG. 4 for instance, determining whether the one or more second criteria are satisfied (at 404b) includes determining whether one or more portions of the user (e.g., a first hand, and a second hand) satisfy a criterion that is satisfied when a first hand is detected performing a first gesture, and a second hand is detected performing a second gesture, wherein the first gesture and the second gesture are optionally detected in association with an object, apportion of an object, and/or a region of the physical environment. In some examples, the criterion is satisfied when a first finger of a first hand is extended, and a second finger of the second hand is extended, wherein the extended fingers are optionally detected in association with an object, a first region of a first object, or a region of the physical environment.

In some examples, the first gesture optionally comprises a first extended finger of the first hand, and the second gesture comprises a second extended finger of the second hand.

In some examples of the present disclosure, the first gesture optionally comprises a first extended finger 309a of a user's first hand 308a, and the second gesture optionally comprises a second extended finger 309b of a user's second hand 308b. While examples shown herein include the use of an extended index finger (309a, 309b) of the user in an extended position, alternate examples wherein the one or more second criteria include a criterion that is satisfied when a thumb, middle finger, ring finger, pinkie finger, or combination thereof are in an extended position, are within the spirit and scope of the present disclosure. Furthermore, in some examples, the user optionally programs and/or trains the electronic device 101 to recognize a custom gesture in the event the user is unable to perform one or more predetermined gestures.

In some examples, the one or more second criteria include a criterion that is satisfied when, while the first hand is performing the first gesture and the second hand is performing the second gesture, the first extended finger and the second extended finger are static. In some examples of the present disclosure, as illustrated in FIGS. 3H-3I for instance, the one or more second criteria are satisfied when the electronic device 101 detects that the first portion of the user (e.g., first hand 308a) and the second portion of the user (e.g., second hand 308b) are static in relation to an object 304, a portion of an object 304, or a region of the physical environment 300. In some examples, the one or more second criteria are optionally satisfied when the electronic device 101 detects that the first extended finger 309a of the user's first hand 308a, and the second extended finger 309b of the user's second hand 308b are static in relation to an object 304, a portion of an object 304, or a region of the physical environment 300. In some examples, the first extended finger 309a and the second extended finger 309b indicate a first region 310c of an object 304 within the physical environment 300. In some examples of the present disclosure, in conjunction with a determination that the one or more second criteria have been satisfied, the electronic device 101 optionally displays a second user interface element (e.g., 318d, 318e).

Additionally or alternatively, in some examples, the one or more second criteria optionally include a criterion that the first portion of the user (e.g., first hand 308a, first extended finger 309a) and a second portion of the user (e.g., second hand 308b, second extended finger 309b) are moving at a velocity less than a threshold velocity.

In some examples of the present disclosure, as illustrated in FIG. 4 for instance, determining whether the one or more second criteria are satisfied (at 404b) optionally includes a criterion that is satisfied when the first portion of the user (e.g., first hand, first extended finger of the first hand) and the second portion of the user (e.g., second hand, second extended finger of the second hand) are determined to be static in relation to an object, portion of an object, and/or the physical environment.

In some examples, in accordance with a determination that the first and the second extended fingers are associated (e.g., aligned) with a string of the textual information associated with the object when the one or more second criteria are satisfied, the electronic device displays the second user interface element in association with the one or more portions of the user. In some examples of the present disclosure, the one or more second criteria optionally include a criterion that is satisfied when the first extended finger 309a and the second extended finger 309b satisfy the one or more second criteria, the electronic device 101 determines whether the first extended finger 309a and the second extended finger 309b are aligned with a string of textual information. A string of textual information, as discussed herein, includes one or more characters of text. Furthermore, a string of textual information of some examples optionally includes a plurality of concatenated characters forming a word, multiple words, a phrase, or at least part of one or more sentences. A string of textual information, in some examples, optionally includes textual information which is displayed horizontally and reads left to right (e.g., English), reads right to left (e.g., Arabic), reads top to bottom (e.g., Japanese), and/or or bottom to top (e.g., Batak). Further still, in some examples, a string of textual information optionally reads in a direction which contrasts to common practice (e.g., stylized text which reads diagonally).

In some examples of the present disclosure, a first extended finger 309a and a second extended finger 309b are optionally determined by the electronic device 101 to be aligned with a string of textual information when both extended fingers are detected as being within a threshold distance of the same line of textual information such as shown in the first region 310c at FIG. 3H for instance.

In some examples of the present disclosure, as illustrated in FIG. 4 for instance, the electronic device optionally identifies a region (at 406b) designated or associated with the one or more portions of the user that satisfy the one or more second criteria. In some examples, the one or more second criteria (at 404b) optionally include a criterion that the one or more portions of a user of the user are associated with a string of textual information. Additionally or alternatively, in some examples, determining whether the one or more portions of a user are associated with a string of textual information optionally occurs in conjunction with identifying the region (at 406b) and/or in conjunction with identifying one or more lines of textual information (at 408b). In some examples, the identifying process (at 406b) optionally includes determining whether the first region includes textual information, wherein the one or more first portions of a user (first extended finger) and the one or more second portions are associated with a string of textual information.

In some examples, the electronic device identifies the string of textual information between the first extended finger and the second extended finger. In conjunction with detecting the first extended finger 309a and the second extended finger 309b as being aligned with a string of textual information, the electronic device 101 optionally identifies the string of textual information as the one or more characters aligned within each other which are detected between the first extended finger 309a and the second extended finger 309b. In the example as illustrated in FIG. 3H, the string of textual information between the first extended finger 309a and the second extended finger 309b includes the phrase “The Mona Lisa is a portrait”.

In some examples of the present disclosure, as illustrated in FIG. 3H for instance, the second user interface element 318d includes handles (e.g., pins 319a, 319b) which allow the user to modify (e.g., shorten or expand) the selection detected within the first region 310c. For instance, the string of textual information that reads, “The Mona Lisa is a” is included within the first region 310c, the is able to optionally adjust the selection to include only “Mona Lisa” for to refine a generated representation of the textual information in the second user interface element 318d for purposes of actions such as saving (e.g., copying) and/or other functions (e.g., look-up).

In some examples of the present disclosure, as illustrated in FIG. 4 for instance, the one or more second criteria (at 404b) optionally include a criterion that is satisfied when the first extended finger of a first hand of the user, and a second extended finger of a second hand of the user, different than the first hand, is detected to be associated with an object, a portion of an object, or a region of the physical environment. When the one or more second criteria are satisfied, the electronic device optionally subsequently identifies a region (at 406b) which the first extended finger and the second extended finger are associated with.

In some examples, as illustrated in FIG. 4 for instance, identifying the region (at 406b) associated with the one or more portions of a user optionally includes identifying an area between the extended fingers such as a line of textual information. In conjunction with identifying the region (at 406b) the electronic device optionally identifies (at 408b) the string of textual information located within the identified region for image processing algorithms should be applied.

In some examples, the electronic device initiates image processing of the string of textual information to generate a representation of the string of textual information. Following, or in conjunction with, identifying the string of textual information, the electronic device 101 optionally initiates one or more image processing algorithms (e.g., OCR) to generate a representation of the string of textual information. The one or more image processing algorithms optionally include Optical Character Recognition (OCR) algorithms which are configured to recognize the textual information for subsequent operations such as displaying, translating, copying, saving, and/or other subsequent processes. The representation of the string of textual information optionally includes a translation of the string of textual information into preferred language designated by a user to the electronic device 101. Furthermore, the representation of the string of textual information includes representing the one or more target words with a graphical representation.

In some examples of the present disclosure, as illustrated in FIG. 4 for instance, the electronic device optionally generates a representation (at 410b) of the of the string of textual information. In some examples, generating a representation optionally includes initiating an OCR algorithm, performing a contextual search, performing an internet search, and/or generating associated information via AI.

In some examples, the electronic device displays the representation of the string of textual information in the second user interface element. In some examples of the present disclosure, following generating the representation of the string of the textual information, the electronic device optionally displays the representation of the string of textual information in the second user interface element 318d such as shown in FIG. 3H for instance. In some examples, in conjunction with displaying the representation of the string of textual information, the electronic device 101 optionally saves the representation of the string of textual information to memory (e.g., actively, passively).

In some examples of the present disclosure, as illustrated in FIG. 4 for instance, in conjunction with generating a representation (at 410b) the electronic device optionally displays a second user interface element (at 412b) to display the generated representation of the string of textual information.

In some examples, after the electronic device initiates the image processing of the string of textual information, the electronic device saves the representation of the string of textual information to memory. Following, or in conjunction with, initiating the image processing of the string of textual information to generate the representation of the string of textual information, the electronic device 101 optionally saves the representation of the string of textual information to memory.

In some examples, as illustrated in FIG. 3H for instance, the electronic device 101 saves the representation of the string of textual information to memory 220 of the electronic device. In some examples of the present disclosure, subsequent to or simultaneously with the initiating image processing (e.g., OCR), the electronic device 101 optionally saves the string of textual information, such as found in the within the first region 310c to memory 220 (e.g., in FIG. 2), such as short-term memory storage (e.g., copy indicated at 322) wherein the user is able to export (e.g., paste) the representation of the string of textual information into alternate applications/files on the electronic device 101, or into applications/files on alternate electronic devices.

In some examples, as shown in FIG. 3H for instance, multiple actions may be taken with respect to the string of textual information. In some such examples, user interface affordances are optionally displayed and selectable to take the desired action with respect to the string of textual information. For example, FIG. 3D illustrates user interface elements (e.g., buttons) that are selectable to perform a copy action or a look-up action on the string of textual information. For example, a first user interface element 322 is selectable to perform a copy action and a second user interface element 321 is selectable to perform a look-up action. In some examples, a user interface element is presented to initiate one action (e.g., a copy user interface button is presented), optionally when another functionality (e.g., look-up) is triggered automatically by the satisfaction of the one or more criteria described herein. It is understood that these user interface affordances and actions are examples, and other user interface affordances (e.g., toggles, sliders, etc.) and actions (e.g., bookmark, share, etc.) could be implemented. Additionally, it is understood that although illustrated in the context of a string of textual information, that the display of user interface element selectable to perform one of multiple actions is optionally implemented in conjunction with the selection of a text or objects using a single finger (e.g., as described with reference to FIGS. 3D-3G). In some examples, as shown in FIG. 3I for instance, the second user interface element 318e includes text in a scrollable format wherein user input (e.g., at scroll bar 323) allows the user to view the entirety of the generated representation of the textual information within first region 310d.

In some examples, the electronic device 101 passively saves the information (e.g., representation of the string of textual information) to memory 220. In some examples, the electronic device optionally saves information to memory 220 following an input from the user instructing the electronic device to save the information. Inputs to save information to memory 220, in some examples, optionally include input(s) received by the electronic device 101 via voice command, option selection (e.g., via touch input, mouse input, keyboard input), gesture from user's hand 308, gesture via user's head movement, or a combination thereof. Additionally or alternatively, the electronic device actively saves information (e.g., representation of the string of textual information) to memory 220 subsequent to (e.g., in response to) an operation (e.g., initiating image processing) wherein the electronic device does not require user input to initiate saving the information to memory.

In some examples of the present disclosure, as illustrated in FIG. 4 for instance, the displaying of the second user interface element (at 412b) includes saving the representation of the textual information to memory (e.g., 220 at FIG. 2).

In some examples, in response to a determination that the first extended finger is moving in relation to the second extended finger, the electronic device forgoes initiating image processing of the string of the textual information. In some examples of the present disclosure, as illustrated in FIG. 3H for instance, the one or more second criteria optionally include a criterion that a first portion of the user (e.g., first hand 308a, first extended finger 309a) and a second portion of the user (e.g., second hand 308b, second extended finger 309b) are static in relation to an object 304 within the physical environment. In some examples, when the electronic device 101 determines that at least one of the first portion of the user and the second portion of the user are not static, the electronic device 101 optionally forgoes initiating image processing of the string of textual information. In some examples, when the electronic device 101 detects that at least one of the first portion of the user and the second portion of the user are not static, the electronic device 101 optionally forgoes initiating image processing of the string of textual information until the electronic device 101 subsequently detects that the first portion of the user and the second portion of the user are static. In some examples, the one or more second criteria optionally include a criterion that the first portion of the user (e.g., first hand 308a, first extended finger 309a) and a second portion of the user (e.g., second hand 308b, second extended finger 309b) are moving at a velocity less than a threshold velocity.

In some examples, subsequent to displaying the first user interface element (at 412b), when the electronic device detects that the one or more portions of a user are moving (at 414b), the electronic device optionally reverts to identifying the region (at 406b) associated with the one or more portions of a user. While detecting whether the one or more portions of a user are moving (at 414b) is described and illustrated as occurring subsequent to displaying the first user interface element (at 412b), detecting of the movement of the one or more portions of a user (at 414b) is optionally conducted prior to, simultaneously with, and/or subsequent to any operation of the method 400 subsequent to determining whether the one or more first criteria have been satisfied (at 404b). In some examples, subsequent to the detection of one or more first portions of a user of the user as moving (at 414b) in relation to the physical environment, the electronic device optionally forgoes subsequent operations until the one or more portions of a user of the user are detected to be subsequently static (at 416b).

In some examples, following the electronic device determining that the first extended finger is moving in relation to the second extended finger, the electronic device subsequently determines that the first and the second extended fingers are static or within a threshold of velocity. In some examples of the present disclosure, as illustrated in FIG. 3H for instance, after the electronic device 101 detects the first portion of the first portion of the user (e.g., first hand 308a, first extended finger 309a) and a second portion of the user (e.g., second hand 308b, second extended finger 309b) wherein at least one of the first portion of the user and the second portion of the user are not static (e.g., moving, moving faster than a threshold velocity) in relation to an object 304 in the physical environment 300, the electronic device 101 subsequently detects that the first portion of the user and the second portion of the user are static in relation to the object 304 within the physical environment 300.

In some examples, the electronic device identifies an updated string of textual information associated with the first extended finger and the second extended finger based on a movement of the first extended finger in relation to the second extended finger. In conjunction with detecting that the first portion of the user (e.g., first hand 308a, first extended finger 309a) and a second portion of the user (e.g., second hand 308b, second extended finger 309b) are subsequently static, the electronic device 101 optionally identifies an updated string of textual information associated with (e.g., between) the first portion of the user and the second portion of the user. In some examples, as illustrated in FIG. 3H, when the first extended finger 309a remains static where shown, and the electronic device 101 detects the second extended finger 309b moving (e.g., traveling horizontally toward the first extended finger 309a), the electronic device 101 optionally continues detecting for the movement of the extended fingers). When the electronic device 101 detects that the first extended finger 309a and the second extended finger 309b are subsequently static in relation to the object 304, and the first extended finger 309a and the second extended finger 309b continue to be aligned with a string of textual information, the electronic device 101 identifies an updated string of textual information. In the example wherein the second extended finger 309b is detected moving toward the first extended finger 309a, and the second finger stops where the string of textual information between the first extended finger 309a and the second extended finger 309b includes the phrase “Mona Lisa is a portrait”, the electronic device 101 identifies an updated string of textual information which includes “Mona Lisa is a portrait” for subsequent processes and/or operations.

In some examples, in accordance with the one or more portions of a user of the user being detected as static (at 416) following detecting the one or more portions of a user as moving (at 414b), the electronic device identifies and/or updates the region (at 406b) associated with the one or more portions of a user (e.g., a first extended finger, and second extended finger) associated an object, wherein the one or more portions of a user are associated with a string of textual information.

In some examples, the electronic device initiates the image processing of the updated string of textual information to generate a representation of the updated string of textual information. In some examples of the present disclosure, as illustrated in FIG. 3H for instance, following identifying an updated string of textual information as associated with the first extended finger 309a and the second extended finger 309b, the electronic device 101 optionally initiates image processing of the updated string of textual information to generate a representation of the updated string of textual information. In some examples, the electronic device 101 has previously identified a string of textual information associated with the one or more portions of the user which satisfied the one or more second criteria, has previously generated a representation of the string of textual information, and has previously displayed the representation of the string of textual information on the second user interface element 318d. When the electronic device 101 detecting motion of the one or more portions of the user (e.g., first extended finger 309a, and second extended finger 309b) results in the electronic device 101 identifying an updated string of textual information, and generating the representation of the updated string of textual information, the electronic device 101 optionally updates the second user interface element 318d to include the representation of the updated string of textual information. In some examples, the electronic device 101 subsequently saves (e.g., actively, passively) the representation of the updated sting of textual information to memory, optionally replacing the previously saved representation of the string of textual information.

In some examples, as illustrated in FIG. 4 for instance, subsequent to identifying one or more lines of textual information (at 408b), the electronic device optionally initiates one or more image processing algorithms to generate a representation (at 410b) of the string of textual information.

In some examples, in accordance with a determination that the first extended finger and the second extended finger are associated with multiple lines of textual information associated with the object when the one or more second criteria are satisfied, the electronic device displays the second user interface element in association with the one or more portions of the user and the object. In some examples of the present disclosure, shown in FIG. 3I for instance, in conjunction with determining that a first portion of a user (e.g., first hand 308a, first extended finger 309a) and a second portion of a user (e.g., second hand 308b, second extended finger 309b) satisfy the one or more second criteria, the electronic device 101 optionally determines whether the first portion of the user and the second portion of the user are associated with multiple lines of textual information. In some examples, the electronic device 101 optionally determines that a first portion of a user (e.g., first hand 308a, first extended finger 309a) and a second portion of a user (e.g., second hand 308b, second extended finger 309b) are associated with multiple lines of textual information when the first portion of the user is associated with a first line 311a of textual information, and the second portion of the user is associated with a second line 311b of textual information, different than the first line of textual information, wherein the first line 311a of textual information and the second line 311b of textual information are optionally within a first region 310d of an object 304 within the physical environment 300.

In some examples of the present disclosure, as illustrated in FIG. 4 for instance, detecting for one or more portions of a user (at 402) and determining of the one or more second criteria are satisfied (at 404b) optionally include a criterion that is satisfied when the one or more portions of a user include one or more first portions of a user (e.g., hand, extended finger) and one or more second portions of a user (e.g., hand, extended finger) which are associated with and/or directed toward multiple lines of textual information on an object, a portion of an object, and/or a region of the physical environment.

In some examples, the electronic device identifies a first region of textual information that includes the multiple lines of textual information based on a position of the first extended finger in relation to the second extended finger. In some examples, in conjunction with the electronic device 101 determining that the one or more second criteria are satisfied, the electronic device optionally identifies a first region 310d of the object 304 associated with the first portion of the user (e.g., first extended finger 309a) and the second portion of the user (e.g., second extended finger 309b) wherein the first region 310d optionally includes textual information. In some examples, the electronic device 101 optionally determines the first region 310d as related to the position of a first extended finger 309a and a second extended finger 309b wherein the extended fingers indicated opposite corners of a rectangularly shaped first region 310d associated with multiple lines of textual information.

In some examples of the present disclosure, as illustrated in FIG. 4 for instance, identifying a first region (at 406a) includes identifying the one or more lines of textual information associated with the position of a first extended finger, and a position of a second extended finger, wherein the extended fingers optionally define corners of a boundary around the multiple lines of textual information.

In some examples, the electronic device initiates image processing of the first region of textual information to generate a representation of the multiple lines of textual information. In conjunction with identifying the first region 310d, the electronic device 101 optionally initiates image processing on the first region 310d of the textual information to generate a representation of the multiple lines of textual information.

In some examples of the present disclosure, as illustrated in FIG. 4 for instance, in conjunction with identifying the first region (at 406b) the electronic device optionally identifies the multiple lines of textual information (at 408b) within the first region, and optionally generates a representation (at 410b) of the multiple lines of textual information.

In some examples, the electronic device displays, via the one or more displays, the representation of the multiple lines of textual information from the first region in the second user interface element.

In some examples, following initiating the image processing of the first region 310d of textual information, the electronic device 101 optionally displays, via the one or more displays 120, the representation of the multiple lines of textual information from the first region 310d within the second user interface element 318e.

In some examples of the present disclosure, as illustrated in FIG. 4 for instance, in conjunction with generating a representation (at 410b) the electronic device optionally displays a second user interface element (at 412b) wherein the second user interface element includes the representation of the multiple lines of textual information.

In some examples, as illustrated in FIG. 3I, the electronic device 101 determines the first region 310d based on the location of the one or more first portions of a user (e.g., first hand 308a, first extended finger 309a) and the one or more second portions of a user (e.g., second hand 308b, second extended finger 309b). Considering the first region 310d for instance, the first extended finger 309a (at FIG. 3I) establishes a bottom right corner of the first region 310d, and the second extended finger 309b establishes a top right corner of the first region 310d. In some examples, to determine the first region 310d, the electronic device establishes a first vertical boundary line originating from the first extended finger that intersects a first horizontal boundary line originating from the second extended finger, and establishes a second vertical boundary line originating from the second extended finger that intersects a second horizontal boundary line originating from the first extended finger, wherein the first region of textual information corresponds to textual information included within an area of the first vertical boundary line, the first horizontal boundary line, the second vertical boundary line, and the second horizontal boundary line. In some examples, as illustrated in FIG. 3I for instance, the electronic device 101 optionally identifies the first region 310d by establishing boundary lines (e.g., 340a-340d) in association with the first portion of the user (e.g., first extended finger 309a) and the second portion of the user (e.g., second extended finger 309b). In some examples, the electronic device 101 optionally detects the first extended finger 309a and establishes a first vertical boundary line 340a originating from the first extended finger 309a, wherein the first vertical boundary line 340a intersects a first horizontal boundary line 340b originating from the second extended finger 109b. Furthermore, the electronic device 101 optionally establishes a second vertical boundary line 340c originating from the second extended finger 309b, wherein the second vertical boundary line 340c intersects a second horizontal boundary line 340d originating from the first extended finger 309a. The intersection of the boundary lines 340a-340d optionally results in a rectangularly shaped first region 310d designating the multiple lines of textual information which the first extended finger 309a and the second extended finger 309b are associated with.

In some examples of the present disclosure, in conjunction with identifying that the first region 310d of the object 304 contains multiple lines of textual information, the electronic device 101 optionally initiates image processing to generate a representation of the multiple lines of textual information from the textual information within the first region 310d. In some examples, subsequent to generating the representation of the multiple lines of textual information, the electronic device 101 optionally displays, via the one or more displays 120, the representation of the multiple lines of textual information in the second user interface element 318e. Furthermore, in some examples, the electronic device 101 saves (e.g., actively, passively) the representation of the multiple lines of textual information to memory 220.

In some examples of the present disclosure, as illustrated in FIG. 4 for instance, identifying the first region (at 406b) optionally includes establishing a first vertical boundary line originating from the first extended finger that intersects a first horizontal boundary line originating from the second extended finger; and establishing a second vertical boundary line originating from the second extended finger that intersects a second horizontal boundary line originating from the first extended finger, wherein the first region of textual information corresponds to textual information included within an area of the first vertical boundary line, the first horizontal boundary line, the second vertical boundary line, and the second horizontal boundary line. In some examples, the boundary lines originating from the extended fingers are optionally non-vertical and non-horizontal wherein the boundary lines are optionally extended to contextually follow the outer extents of the multiple lines of textual information associated with the extended fingers. For instance, in the event that the first finger shown in FIG. 3I were placed immediately following the phrase “artwork of all time.” The electronic device 101 would optionally establish the first region 310d similarly, or identically, as currently illustrated in FIG. 3I.

In some examples, as illustrated in FIG. 3I for instance, the electronic device 101 optionally saves the representation of the string of textual information to memory 220 (at FIG. 2) of the electronic device. In some examples of the present disclosure, subsequent to or simultaneously with the initiating image processing (e.g., OCR), the electronic device 101 optionally saves the string of textual information, such as found in the within the first region 310c to memory 220 (e.g., in FIG. 2), such as short-term memory storage (e.g., copy indicated at 320) wherein the user is able to optionally export (e.g., paste) the representation of the string of textual information into alternate applications/files on the electronic device 101, or into applications/files on alternate electronic devices (e.g., in communication with electronic device 101).

In some examples, the electronic device detects, after identifying the first region of textual information, movement of one or more of the first and the second extended fingers. In some examples of the present disclosure, as illustrated in FIGS. 3I-3J for instance, after satisfying the one or more criteria, including a criterion that a first extended finger 309a and a second extended finger 309b are detected as being static while associated with the first region 310d, when one of the first extended finger 309a and the second extended finger 309b are detected as moving (e.g., movement 342) in relation to the first region 310d, the electronic device 101 optionally performs subsequent operations to update the first region 310d in accordance with the movement of the first extended finger 309a and the second extended finger 309b, and/or optionally identifying a second region 310e associated with the updated location of the first extended finger 309a and the second extended finger 309b.

In some examples, subsequent to determining that the one or more first criteria are satisfied (at 404b), such as after displaying the first user interface element (at 412b), when the electronic device detects that the one or more portions of a user are moving (at 414b), the electronic device optionally reverts to identifying the region (at 406b) associated with the one or more portions of a user. While detecting movement of the one or more portions of a user (at 414b) is described and illustrated as occurring subsequent to displaying the first user interface element (at 412b), detecting of the movement of the one or more portions of a user (at 414b) is optionally conducted prior to, simultaneously with, and/or subsequent to any operations of the method 400 subsequent to determining whether the one or more first criteria have been satisfied (at 404b). In some examples, subsequent to the detection of one or more first portions of a user of the user as moving (at 414b) in relation to the physical environment, the electronic device optionally forgoes subsequent operations until the one or more portions of a user of the user are detected to be subsequently static (at 416b).

In some examples, following detecting the movement of the one or more of the extended fingers of the user, in accordance with a determination that the extended fingers are subsequently static, the electronic device identifies a second region of textual information, different from the first region of textual information, that includes multiple lines of textual information associated with the first extended finger and the second extended finger based on an updated position of the first extended finger in relation to the second extended finger.

In some examples of the present disclosure, as illustrated in FIGS. 3I-3J for instance, in conjunction with detection of the movement 342 of the first extended finger 309a and/or movement of the second extended finger 309b in relation to the object 304, the electronic device 101 detects for the first extended finger 309a and the second extended finger 309b to be subsequently static in relation to the object 304. Upon detecting the extended fingers (309a, 309b) as static, and in accordance with the extended fingers (309a, 309b) satisfying the one or more second criteria, the electronic device identifies a second region 310e in accordance with the updated location of the extended fingers (309a, 309b) in relation to the object 304. Additionally or alternatively, the electronic device 101 optionally updates the first region 310d in accordance with the updated location of the extended fingers (309a, 309b) in relation to the object 304. Following identifying a second region 310e, the electronic device 101 optionally initiates the image processing on updated textual information detected within the he second region 310e to generate a representation of the multiple lines of textual information detected within the second region 310e. In conjunction with the image processing, the electronic device 101 optionally updates the second user interface element 318e to include the generated representation of the textual information detected within the second region 310e.

In some examples of the present disclosure, as illustrated in FIG. 4 for instance, following detecting the movement of the one or more portions of a user (at 414b), the electronic device optionally detects whether the one or more portions of a user are subsequently static (at 416b). In the event that the one or more portions of a user are detected to be subsequently static (at 416b), the electronic device subsequently identifies a second region (at 406b) which the updated location of the one or more portions of a user are associated with. Additionally or alternatively, upon detecting that the one or more portions of a user are subsequently static (at 416b), identifying the region (at 406b) optionally includes updating the first region (at 406b) in association with the updated locations of the one or more portions of a user.

While detecting whether the one or more portions of a user are moving (at 414b) is described and illustrated as occurring subsequent to displaying the first user interface element (at 412b), detecting of the movement of the one or more portions of a user (at 414b) is optionally conducted prior to, simultaneously with, and/or subsequent to any operation of the method 400 subsequent to determining whether the one or more first criteria have been satisfied (at 404b). In some examples, subsequent to the detection of one or more first portions of a user of the user as moving (at 414b) in relation to the physical environment, the electronic device optionally forgoes subsequent operations until the one or more portions of a user of the user are detected to be subsequently static (at 416b).

In some examples, the electronic device performs image processing of the second region of textual information to generate a representation of the multiple lines of textual information included in the second region of textual information. In some examples of the present disclosure, as illustrated in FIG. 4 for instance, optionally following identifying a second region and/or updating the first region (at 406b), the electronic device optionally identifies the multiple lines of textual information (at 408b) and generates a representation of the multiple lines of textual information (at 410b) prior to displaying the displaying of a third user interface element (at 412b) and/or updating the second user interface element (at 412b) with the newly generated representation of the multiple lines of textual information.

In some examples, an electronic device comprises one or more processors in communication with one or more displays and one or more input devices. In some examples, the electronic device further comprises memory, and/or one or more programs, wherein the one or more programs are stored in the memory and configured to be executed by the one or more processors, for performing the method 400 as illustrated in FIG. 4. In some examples, as described herein and as illustrated in FIGS. 1-4, the present disclosure relates to an electronic device 101 which is in communication with one or more displays 120, one or more processors 218, one or more programs (e.g., saved and executed from memory 220) for performing any one or the methods or scenarios described and illustrated herein.

In some examples, the electronic device comprises a non-transitory computer readable storage medium storing one or more programs, wherein the one or more programs comprise instructions, which when executed by one or more processors of an electronic device in communication with a display and one or more input devices, cause the electronic device to perform a method 400, such as illustrated in FIG. 4. In some examples, as described herein and as illustrated in FIGS. 1-4, the present disclosure includes a computer readable storage medium (e.g., memory 220) storing one or more programs therein. The one or more programs are optionally executed by one or more processors 218 in communication with one or more displays 120 and one or more device inputs (e.g., one or more hand tracking sensors 202, one or more location sensors 204A and/or 204B, one or more image sensors 206A and/or 206B, one or more touch sensitive surfaces 209A and/or 209B, one or more orientation sensors 210A and/or 210B, one or more eye tracking sensors 212, and/or one or more microphones 213A and/or 213B.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

1. A method comprising:
at an electronic device in communication with one or more displays, one or more input devices, and one or more optical sensors:
detecting, via the one or more optical sensors, one or more portions of a user directed toward a first object in a physical environment; and
in response to detecting the one or more portions of the user:
in accordance with a determination that the one or more portions of the user being directed toward the first object satisfies one or more first criteria, presenting first content in association with the one or more portions of the user and the first object, the first content including informational content associated with the first object; and
in accordance with a determination that the one or more portions of the user being directed toward the first object satisfies one or more second criteria, different from the one or more first criteria, presenting second content in association with the one or more portions of the user and the first object.

2. The method of claim 1, wherein one or more portions of the first object comprise textual information.

3. The method of claim 2, wherein:
the one or more first criteria include a criterion that is satisfied when the one or more portions of the user are detected as performing a first gesture; and
in response to satisfying the one or more first criteria, and in accordance with the first gesture being associated with one or more target words of the textual information when the one or more first criteria are satisfied, presenting the first content in association with the one or more portions of the user and the first object includes:
performing one or more image processing algorithms on the one or more target words to generate a representation of the one or more target words; and
presenting the representation of the one or more target words with the first content.

4. The method of claim 1, wherein the one or more second criteria include a criterion that is satisfied when the one or more portions of the user include a first hand performing a first gesture, and a second hand, different than the first hand, performing a second gesture.

5. The method of claim 1, wherein presenting the first content includes presenting, via one or more displays, a first user interface element including the informational content associated with the first object.

6. The method of claim 1, wherein presenting the first content includes presenting, via one or more speakers, audible informational content.

7. The method of claim 6, wherein presenting the second content includes presenting, via the one or more speakers, audible informational content.

8. The method of claim 1, wherein presenting the second content includes presenting, via the one or more displays, a second user interface element including the informational content associated with the first object.

9. An electronic device, comprising:
one or more processors;
memory; and
one or more programs, wherein the one or more programs are stored in the memory and configured to be executed by the one or more processors, the one or more programs including instructions for:
detecting, via one or more optical sensors, one or more portions of a user directed toward a first object in a physical environment; and
in response to detecting the one or more portions of the user:
in accordance with a determination that the one or more portions of the user being directed toward the first object satisfies one or more first criteria, presenting first content in association with the one or more portions of the user and the first object, the first content including informational content associated with the first object; and
in accordance with a determination that the one or more portions of the user being directed toward the first object satisfies one or more second criteria, different from the one or more first criteria, presenting second content in association with the one or more portions of the user and the first object.

10. The electronic device of claim 9, wherein one or more portions of the first object comprise textual information.

11. The electronic device of claim 10, wherein:
the one or more first criteria include a criterion that is satisfied when the one or more portions of the user are detected as performing a first gesture; and
in response to satisfying the one or more first criteria, and in accordance with the first gesture being associated with one or more target words of the textual information when the one or more first criteria are satisfied, presenting the first content in association with the one or more portions of the user and the first object includes:
performing one or more image processing algorithms on the one or more target words to generate a representation of the one or more target words; and
presenting the representation of the one or more target words with the first content.

12. The electronic device of claim 9, wherein the one or more second criteria include a criterion that is satisfied when the one or more portions of the user include a first hand performing a first gesture, and a second hand, different than the first hand, performing a second gesture.

13. The electronic device of claim 9, wherein presenting the first content includes presenting, via one or more displays, a first user interface element including the informational content associated with the first object.

14. The electronic device of claim 9, wherein presenting the first content includes presenting, via one or more speakers, audible informational content.

15. The electronic device of claim 14, wherein presenting the second content includes presenting, via the one or more speakers, audible informational content.

16. The electronic device of claim 9, wherein presenting the second content includes presenting, via the one or more displays, a second user interface element including the informational content associated with the first object.

17. A non-transitory computer readable storage medium storing one or more programs, the one or more programs comprising instructions, which when executed by one or more processors of an electronic device, cause the electronic device to:
detect, via one or more optical sensors, one or more portions of a user directed toward a first object in a physical environment; and
in response to detecting the one or more portions of the user:
in accordance with a determination that the one or more portions of the user being directed toward the first object satisfies one or more first criteria, present first content in association with the one or more portions of the user and the first object, the first content including informational content associated with the first object; and
in accordance with a determination that the one or more portions of the user being directed toward the first object satisfies one or more second criteria, different from the one or more first criteria, present second content in association with the one or more portions of the user and the first object.

18. The non-transitory computer readable storage medium of claim 17, wherein one or more portions of the first object comprise textual information.

19. The non-transitory computer readable storage medium of claim 18, wherein:
the one or more first criteria include a criterion that is satisfied when the one or more portions of the user are detected as performing a first gesture; and
in response to satisfying the one or more first criteria, and in accordance with the first gesture being associated with one or more target words of the textual information when the one or more first criteria are satisfied, presenting the first content in association with the one or more portions of the user and the first object includes:
performing one or more image processing algorithms on the one or more target words to generate a representation of the one or more target words; and
presenting the representation of the one or more target words with the first content.

20. The non-transitory computer readable storage medium of claim 17, wherein the one or more second criteria include a criterion that is satisfied when the one or more portions of the user include a first hand performing a first gesture, and a second hand, different than the first hand, performing a second gesture.

21. The non-transitory computer readable storage medium of claim 17, wherein presenting the first content includes presenting, via one or more displays, a first user interface element including the informational content associated with the first object.

22. The non-transitory computer readable storage medium of claim 17, wherein presenting the first content includes presenting, via one or more speakers, audible informational content.

23. The non-transitory computer readable storage medium of claim 22, wherein presenting the second content includes presenting, via the one or more speakers, audible informational content.

24. The non-transitory computer readable storage medium of claim 17, wherein presenting the second content includes presenting, via the one or more displays, a second user interface element including the informational content associated with the first object.
